(19) United States
(12) Patent Application Publication
(10) Pub. No.: US 2026/0289475 A1
(43) Pub. Date: Sep. 24, 2026

(54) SYSTEM

(71) Applicant: SoftBank Group Corp., Tokyo (JP)

(72) Inventor: Shengzhe LI, Tokyo (JP)

(73) Assignee: SoftBank Group Corp., Tokyo (JP)

(21) Appl. No.: 19/565,536

(22) Filed: Mar. 13, 2026

(30) Foreign Application Priority Data
Mar. 19, 2025 (JP) 2025-044926

(51) Int. Cl. G06Q 10/0639

(52) U.S. Cl. CPC G06Q 10/06398

(57) ABSTRACT

A system includes a processor that is configured to: acquire performance information, skill information, and behavioral evaluation information of employees by using a sensor or an input device; store the acquired evaluation information in a data storage device; analyze the stored evaluation information by using a statistical method or a machine learning algorithm; and input a prompt to a generative AI model to instruct generation of a detailed evaluation report and cause the detailed evaluation report to be generated.

### CROSS-REFERENCE TO RELATED APPLICATION

This application is based on and claims priority under 35 USC 119 from Japanese Patent Application No. 2025-044926 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional personnel evaluation systems primarily rely on manual input and rule-based processing, which leads to several problems. First, performance information, skill information, and behavioral evaluation information of employees are often collected in a fragmented and inconsistent manner across multiple tools or paper-based forms, making it difficult to manage and analyze the information in an integrated way. Second, the analysis of evaluation information is frequently limited to simple aggregation or static statistical reports, which do not fully utilize advanced analytical techniques such as machine learning. As a result, it is difficult to extract nuanced insights regarding employees' strengths, weaknesses, and development needs. Third, the creation of detailed evaluation reports and training program proposals is typically performed manually by managers or human resources personnel, which is time-consuming, subjective, and not scalable for large organizations. Accordingly, there is a need for a system that can automatically acquire and store various types of employee evaluation information, analyze the stored information using advanced analytical methods, and automatically generate detailed evaluation reports and training program proposals by utilizing a generative AI model, thereby improving the efficiency, consistency, and objectivity of personnel evaluations and career development support.

### SUMMARY

In order to solve the above-described problems, the present invention provides a system comprising a processor, wherein the processor is configured to acquire performance information, skill information, and behavioral evaluation information of employees by using a sensor or an input device, and to store the acquired evaluation information in a data storage device. The processor is further configured to analyze the stored evaluation information by using a statistical method or a machine learning algorithm, thereby generating analysis results that reflect patterns and tendencies in the evaluation information. The processor is further configured to input, to a generative AI model, a prompt that instructs generation of a detailed evaluation report, and to cause the generative AI model to generate the detailed evaluation report on the basis of the analysis results. In addition, the processor is configured to input, to the generative AI model, a prompt that instructs proposal of a training program for improving skills of the employees, and to cause the generative AI model to generate the training program based on the evaluation information and the analysis results. Furthermore, the processor is configured to generate an evaluation result based on the analysis result and to display the evaluation result on a display device through a user interface. By these means, the system automatically performs integrated acquisition, storage, analysis, and generative report creation for employee evaluation information, thereby enabling efficient, consistent, and highly informative personnel evaluations and training proposals.

The term “system” refers to a combination of hardware and software components including at least one processor and one or more storage and input/output devices, which cooperate to execute the processing defined in the claims.

The term “processor” refers to one or more hardware processing units, such as a central processing unit (CPU), graphics processing unit (GPU), or dedicated accelerator, which execute instructions to perform the acquisition, storage, analysis, and control operations described in the claims.

The term “sensor” refers to any hardware device that detects or measures a physical quantity or state, such as a biometric sensor, motion sensor, camera, microphone, or environmental sensor, and outputs corresponding digital or analog data usable as part of the employee evaluation information.

The term “input device” refers to any device or interface through which a user can input data into the system, including but not limited to a keyboard, mouse, touch panel, microphone, camera, or graphical user interface for entering evaluation scores and comments.

The term “employee” refers to a person who belongs to an organization, such as a company or institution, and whose job performance, skills, and behavior are subject to evaluation by the system.

The term “performance information” refers to information that represents quantitative or qualitative results of an employee's work, such as sales amount, achievement rate, number of new customers, project completion metrics, or other indicators of work outcomes.

The term “skill information” refers to information that represents the abilities or competencies of an employee, such as language proficiency, IT skills, leadership ability, domain knowledge, or other professional or technical skills.

The term “behavioral evaluation information” refers to information that represents the observable behavior, attitude, or conduct of an employee in a work environment, such as communication ability, problem-solving ability, teamwork, initiative, or adherence to organizational rules.

The term “evaluation information” refers to a collective set of performance information, skill information, and behavioral evaluation information relating to one or more employees, including scores, ratings, comments, and other associated metadata.

The term “data storage device” refers to any non-transitory storage medium or subsystem, such as a hard disk drive, solid-state drive, semiconductor memory, or cloud storage service, which stores evaluation information, analysis results, and generated data in a readable and writable form.

The term “statistical method” refers to a computational technique that applies statistics to evaluation information, such as calculation of averages, variances, trends, correlations, or clustering, in order to derive analysis results.

The term “machine learning algorithm” refers to an algorithm that automatically learns patterns or models from data, including but not limited to supervised learning, unsupervised learning, or reinforcement learning methods, and that is applied to evaluation information to generate analysis results or predictions.

The term “analysis result” refers to information generated by applying a statistical method or a machine learning algorithm to the stored evaluation information, including derived indicators such as strengths, weaknesses, trends, scores, classifications, or predictions regarding employees.

The term “generative AI model” refers to an artificial intelligence model capable of generating new content, such as text, based on input prompts, and includes, for example, large language models or other generative models that produce evaluation reports or training program descriptions.

The term “prompt” refers to data, typically in the form of text or structured information, that is input to the generative AI model in order to instruct the generative AI model to perform a specific generative task, such as creating a detailed evaluation report or proposing a training program.

The term “detailed evaluation report” refers to a document or data set generated by the generative AI model that provides a comprehensive description or analysis of an employee's performance, skills, and behavior, including explanations, summaries, and recommendations based on the evaluation information and analysis results.

The term “training program” refers to a structured set of activities, courses, materials, or recommendations intended to improve one or more skills or competencies of employees, and may include program names, objectives, curricula, schedules, and participation instructions.

The term “evaluation result” refers to information derived from the analysis result and representing the outcome of an employee evaluation, such as aggregated scores, ratings, qualitative assessments, or overall evaluations suitable for presentation to a user.

The term “user interface” refers to a software component or screen arrangement that enables a user to interact with the system, including inputting data and viewing evaluation results, reports, or training program information on a display device.

The term “display device” refers to any device capable of visually presenting information to a user, such as a computer monitor, tablet display, smartphone display, or other screen used to display the evaluation result, detailed evaluation report, or training program.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

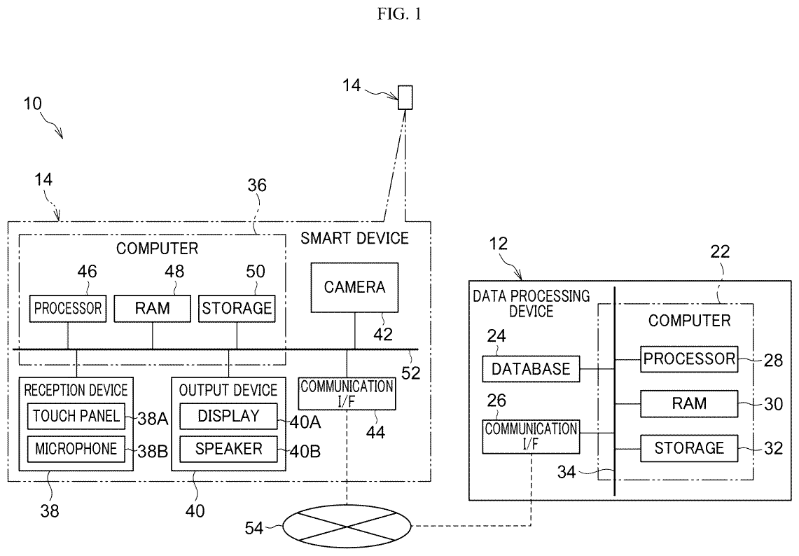

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

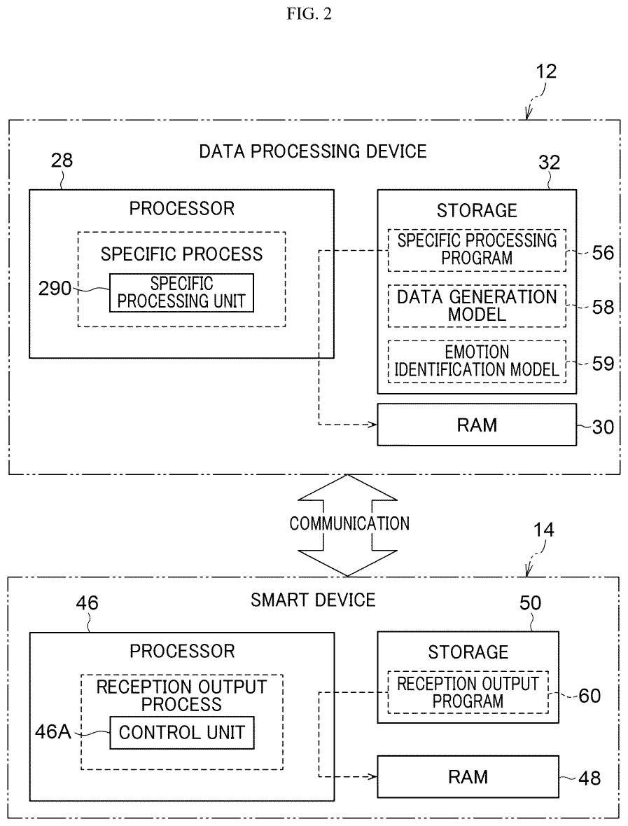

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional personnel evaluation systems typically collect evaluation information as static records and perform limited aggregation or scoring functions. In many implementations, separate software components or different information processing systems are used for data collection, tabular analysis, and narrative report drafting. As a result, end-to-end processing from raw evaluation data to human-readable reports involves multiple manual steps, ad-hoc toolchains, and non-standardized workflows. This fragmented architecture leads to several technical problems.

First, a conventional system is not configured to tightly integrate structured statistical analysis with generation of natural-language evaluation reports. Unstructured narrative evaluations are often prepared manually or in external applications, without systematic reuse of the underlying structured data and computed metrics. This separation can cause inconsistencies between tabular scores and narrative descriptions, redundant data handling, and increased processing latency, thereby reducing the reliability and efficiency of the information processing as a whole.

Second, typical systems do not provide a programmatic mechanism for constructing and managing prompt sentences and contextual data that are suitable for input to a generative AI model. In many cases, a human operator must manually copy numerical results and textual feedback into a free-form instruction to the generative AI model. This manual composition of prompts is error-prone, does not scale to large numbers of evaluation subjects or groups, and does not guarantee that all relevant statistics and trends are consistently provided to the generative AI model. As a result, generated reports may omit critical information, vary greatly in quality, and be difficult to trace back to the underlying data.

Third, existing architectures do not fully automate the iterative refinement of generated reports based on modifications to prompt sentences and associated evaluation context. When a user desires a different focus, level of detail, or aggregation level (for example, individual-level versus group-level reports), the user typically must reconstruct the input to the generative AI model and manually realign the output with the original analysis. This creates friction in practical use, and inhibits dynamic, data-driven exploration of evaluation results.

Fourth, in many conventional systems, evaluation data are stored in heterogeneous formats or loosely structured repositories. This limits the ability of the processor to systematically perform preprocessing, normalization, weighted calculations, ranking computations, and trend analysis across large sets of evaluation subjects. Without such integrated numeric processing, a system cannot reliably generate comprehensive evaluation indices, group-level distributions, and temporal trends that are suitable for downstream consumption by a generative AI model.

Accordingly, there is a need for an improved computer-implemented system that: (i) acquires and stores evaluation information as structured data in a relational data management device; (ii) performs systematic preprocessing and weighted analysis to compute comprehensive evaluation indices and ranking information; (iii) programmatically constructs prompt sentences and evaluation context that incorporate both raw evaluation information and computed metrics; (iv) supplies this combined context to a generative AI model in a standardized, machine-processable manner; and (v) supports iterative, user-driven refinement of generated evaluation reports, while maintaining a coherent association between prompts, underlying data, and generated outputs. Such a system would improve the functioning of the computer by reducing manual intervention, enforcing consistent data flows from acquisition through analysis to natural-language generation, and enabling scalable, automated generation and regeneration of detailed evaluation reports for individuals and groups.

The specific processing by the specific processing unit 290 of the data processing device 12 in Example 1 is realized by the following means.

The present invention provides a server comprising a processor configured to acquire, via an input component, evaluation information including information related to work results, information related to abilities, and information related to behavioral characteristics of evaluation subjects; to store, via a communication function and a data management function, the evaluation information as structured data in a relational data management device while logically associating and retaining the evaluation information on the basis of identification information and period information; to obtain, via a computation function and data analysis software, the evaluation information from the relational data management device and perform preprocessing, numerical conversion, scale normalization, aggregation processing, and weighted calculation on the evaluation information to compute, for each evaluation subject, a comprehensive evaluation index and ranking information, and to store the computed comprehensive evaluation index and the ranking information as evaluation result data in the relational data management device; to generate a prompt sentence, as an instruction sentence to be input to a generative AI model, the prompt sentence incorporating, in a text format or a structured data format, an evaluation context including at least a part of the evaluation information, the comprehensive evaluation index, and the ranking information; to transmit the prompt sentence and the evaluation context to the generative AI model and acquire, from the generative AI model, detailed evaluation report information expressed in a natural language; and to output, via a display component, the detailed evaluation report information and the comprehensive evaluation index as display information for a user. This enables the computer system to implement an integrated, end-to-end pipeline in which structured evaluation data are consistently acquired, normalized, analyzed, and transformed into natural-language evaluation reports, to reduce manual preparation of prompts and narrative content, to improve the consistency and traceability between underlying evaluation metrics and generated reports, and to support scalable, iterative refinement of both individual-level and group-level evaluation outputs through programmatic control of prompt sentences and evaluation context.

The term “evaluation information” refers to electronic data representing assessments of evaluation subjects, including at least information related to work results, information related to abilities, and information related to behavioral characteristics, and optionally including numerical scores, categorical ratings, and textual feedback.

The term “work results” refers to performance-related information for an evaluation subject, including quantitative or qualitative indicators of task completion, productivity, achievement of targets, or contribution to organizational objectives.

The term “abilities” refers to information representing skills, knowledge, competencies, or qualifications of an evaluation subject, including technical abilities, cognitive abilities, and interpersonal abilities, expressed as numerical scores, ratings, or descriptive data.

The term “behavioral characteristics” refers to information representing observable actions, attitudes, or conduct of an evaluation subject in a work environment, including collaboration behavior, communication behavior, leadership behavior, and compliance behavior.

The term “evaluation subject” refers to an individual or entity whose performance, abilities, or behavior are assessed by the system, such as an employee, a contractor, or a member of an organizational unit.

The term “input component” refers to a hardware and/or software component configured to receive data from a user or an external device, including but not limited to a user interface, a sensor, a keyboard, a pointing device, or a network-based input interface.

The term “display component” refers to a hardware and/or software component configured to output visual information to a user, including but not limited to a display device, a graphical user interface, or a web-based presentation module.

The term “communication function” refers to a hardware and/or software function that enables transmission and reception of data between the processor and external devices or services over a communication network.

The term “data management function” refers to a hardware and/or software function that controls storage, retrieval, update, and logical organization of data in one or more storage devices.

The term “relational data management device” refers to a data storage and management system that stores data in tables having rows and columns, supports relational operations including joins and constraints, and is controlled by a relational database management system.

The term “structured data” refers to data organized according to a predefined schema, such as tables, records, and fields, enabling query, indexing, and relational operations by a database management system.

The term “identification information” refers to data used to uniquely or distinctively identify an evaluation subject, a record, or an entity within the system, including identifiers such as an employee ID, a user ID, or an object ID.

The term “period information” refers to data representing a time interval, date, or time stamp associated with evaluation information, including evaluation periods, reporting periods, or time-based versions of records.

The term “computation function” refers to a hardware and/or software function that performs arithmetic operations, logical operations, and data processing operations on input data, including statistical computations and aggregation functions.

The term “data analysis software” refers to software components or libraries executed by the processor to perform data preprocessing, statistical analysis, numerical computation, or machine learning on evaluation information.

The term “preprocessing” refers to operations applied to raw evaluation information before primary analysis, including cleaning, validation, transformation, handling of missing values, and formatting into analysis-ready structures.

The term “numerical conversion” refers to processing that transforms qualitative or categorical evaluation information into numeric values, or rescales numeric values, for use in computations and comparisons.

The term “scale normalization” refers to processing that converts evaluation scores having different ranges or scales into a common scale, thereby enabling consistent aggregation, comparison, or weighting across multiple indicators.

The term “aggregation processing” refers to processing that combines multiple data items, such as multiple scores or records, into summary values, such as sums, averages, or composite indicators.

The term “weighted calculation” refers to processing that multiplies evaluation indicators by corresponding weight values and combines them to produce weighted sums or composite scores.

The term “comprehensive evaluation index” refers to a computed metric representing an overall evaluation of an evaluation subject, derived from one or more evaluation indicators through at least aggregation processing and weighted calculation.

The term “ranking information” refers to data indicating a relative order or position of an evaluation subject among multiple evaluation subjects, based on one or more evaluation indices or scores.

The term “evaluation result data” refers to data representing outputs of analysis performed on evaluation information, including comprehensive evaluation indices, ranking information, and optionally derived metrics and summaries.

The term “evaluation context” refers to a set of data and/or textual information that provides background, parameters, and content related to an evaluation of one or more evaluation subjects, including at least a part of the evaluation information, the comprehensive evaluation index, the ranking information, or group-level aggregates.

The term “prompt sentence” refers to a natural-language or structured instruction sentence that is configured to be input to a generative AI model or generative information processing model, and that specifies a request for generation of evaluation report information based on an evaluation context.

The term “generative AI model” refers to a machine-implemented model configured to generate output data such as natural-language text in response to input data including a prompt sentence and contextual information, using learned statistical or neural network parameters.

The term “generative information processing model” refers to a generative AI model or a functionally equivalent generative computational model that, given input including a prompt sentence and contextual data, produces generated information such as natural-language evaluation reports.

The term “detailed evaluation report information” refers to natural-language or structured text generated by the generative information processing model, describing, at a greater level of detail than raw scores alone, performance, abilities, behavioral characteristics, strengths, weaknesses, and recommendations relating to one or more evaluation subjects.

The term “set of evaluation subjects” refers to a plurality of evaluation subjects that are grouped according to at least one attribute, such as belonging to a same organizational unit, role, project, or time period.

The term “ability distribution” refers to information representing a statistical distribution of ability-related indicators across a set of evaluation subjects, including measures such as averages, variances, or histograms of ability scores.

The term “behavioral characteristic distribution” refers to information representing a statistical distribution of behavioral-related indicators across a set of evaluation subjects, including measures such as averages, variances, or histograms of behavioral scores.

The term “temporal change tendencies” refers to information representing how evaluation indicators, comprehensive evaluation indices, or distributions change over time for an individual evaluation subject or a set of evaluation subjects.

The term “set-level evaluation context” refers to an evaluation context that is constructed for a set of evaluation subjects and that includes group-level information such as ability distributions, behavioral characteristic distributions, and temporal change tendencies.

The term “training policy” refers to a strategy or guideline describing types, priorities, and allocation of training or educational activities for one or more evaluation subjects or groups.

The term “ability improvement plan” refers to a schedule or plan specifying concrete actions, programs, or targets designed to enhance one or more abilities of an evaluation subject or a set of evaluation subjects.

The term “display information” refers to information formatted and output by the system for presentation to a user via a display component, and may include text, graphics, tables, or interactive elements representing evaluation results and reports.

The term “operation input” refers to a user action received by the system through an input component or user interface, including selection, editing, confirmation, or modification commands related to evaluation data, prompt sentences, or reports.

The term “updated evaluation report information” refers to detailed evaluation report information newly generated by the generative information processing model in response to a modified prompt sentence or a modified evaluation context.

In one embodiment, a server implements the claimed system by executing a set of software modules on a general-purpose computing platform. The server includes at least one central processing unit, a volatile memory device, a non-volatile storage device, a network interface controller, and a display interface. The server executes an operating system such as a general-purpose server operating system and runs application software that implements a data acquisition module, a relational data management module, an analysis module, a prompt construction module, a generative AI access module, and a presentation module.

Server acquires evaluation information by receiving electronic input from terminals operated by users. Terminal is a computing device such as a personal computer, tablet device, or smartphone, running a web browser or a dedicated application. Terminal displays an input screen implemented with a user interface framework, including fields for work result indicators, ability indicators, and behavioral indicators. User operates the terminal to enter, for example, numerical values for sales amounts, achievement rates, numbers of new clients, and scale-based ratings for abilities such as language skills, information technology skills, and problem-solving abilities, as well as for behavioral characteristics such as leadership, communication, and teamwork. User may also enter free-text feedback comments.

Server receives these data via an application programming interface (API) over a network protocol such as HTTPS. Server validates the incoming payload, checking data types, numeric ranges, and the existence of an associated evaluation subject identifier. By implementing validation logic in the server application layer, the system avoids writing malformed records into storage, which improves integrity and reduces later correction overhead.

Server stores the evaluation information as structured data in a relational data management device. The relational data management device can be implemented as a relational database management system (RDBMS) such as a general-purpose relational database product, running on the same or a different physical machine. Server uses a database access library or object-relational mapping framework to issue data manipulation commands. Server defines relational schemas with tables such as an evaluation subject table, an evaluation record table, a score detail table, and a feedback table. Each table includes fields for identification information, period information, and various indicator values.

Server maintains foreign key relationships such that each evaluation record is linked to an evaluation subject and to a particular evaluation period. By enforcing referential integrity at the RDBMS level, the system ensures that downstream analysis always references consistent subject and time-period identifiers. Server indexes key columns by creating database indices on subject identifiers, period identifiers, and composite keys of subject and period. These indices allow the analysis module to execute complex queries over large data sets with reduced latency, thereby improving the technical performance of the data retrieval operations.

Server analyzes the stored evaluation information by executing a data analysis module, implemented using a numerical computing environment such as a scripting language runtime combined with analysis libraries. Server loads selected records into an in-memory data structure such as a table representation with rows corresponding to evaluation records and columns corresponding to indicators. Server executes preprocessing operations including removal of inconsistent records, imputation or marking of missing values, and normalization of rating scales. For example, when some ability ratings are provided on a 1-5 scale and others on a 0 -100 scale, server converts all ratings to a unified 0 -100 scale through linear transformation. This normalization reduces numeric distortion and permits aggregation without manual reconciliation, which is technically advantageous.

Server performs numerical conversion of categorical or qualitative labels into numeric codes where necessary. For example, server maps textual assessment levels such as “Excellent,” “Good,” and “Needs Improvement” to numeric values such as 100, 80, and 50, respectively. Server then performs aggregation processing by grouping multiple records per evaluation subject and computing summary statistics, such as mean, median, and standard deviation of scores across periods or feedback sources. Server applies weighted calculation by multiplying each indicator by a configured weight coefficient stored in a configuration table. For instance, server may apply a 0.5 weight to performance metrics, a 0.3 weight to ability metrics, and a 0.2 weight to behavioral metrics. Server computes a comprehensive evaluation index per evaluation subject as a weighted sum or weighted average of normalized indicators.

Server computes ranking information by sorting the comprehensive evaluation indices for a population of evaluation subjects within a specified unit such as a department. Server uses efficient sorting algorithms provided by the numerical computing libraries to order subjects and assign ranking positions. Server may also compute percentile ranks and deviation scores. Server writes the resulting comprehensive evaluation indices, ranking positions, and derived metrics back into the relational data management device as evaluation result data, associated by subject and period identifiers. This repeated writing of derived data into a structured schema allows future queries to access precomputed scores and ranks without re-running the full analysis, which reduces CPU usage and improves response time for repeated accesses.

Server constructs an evaluation context for each evaluation subject or group of subjects when a detailed narrative report is needed. Server retrieves, from the relational data management device, both the raw evaluation information and the computed evaluation result data. Server organizes these data into a structured representation, such as a hierarchical data object or a concatenated textual summary, describing for each subject: the comprehensive evaluation index, ranking information, breakdown of indicators, and temporal change tendencies across multiple periods. For sets of evaluation subjects, server additionally computes and describes group-level statistics such as ability distributions, behavioral characteristic distributions, and changes in those distributions over time.

Server generates a prompt sentence as an instruction to a generative AI model. In one example, server creates a prompt sentence such as: “Using the latest evaluation scores and feedback for Employee A, produce a detailed report of strengths, weaknesses, and recommended training courses for the next 12 months.” In another example, server creates a prompt sentence such as: “Based on Employee A's total evaluation score, department ranking, and recent trend of improvement, assess the likelihood of promotion within the next evaluation cycle and recommend three specific development actions.” In a further example, for a group-level report, server constructs a prompt sentence such as: “Using the evaluation data and feedback for all members of Team C, summarize key strengths, identify common skill gaps, and propose a six-month training and coaching plan to improve overall team performance.”

Server programmatically constructs these prompt sentences rather than relying solely on user input. Server may insert computed values, such as current comprehensive evaluation index, relative percentile, and degree of improvement, into templated text segments. This programmatic construction ensures that the generative AI model always receives a complete and well-structured description of the evaluation targets, which leads to more consistent output and reduces the need for manual editing.

Server transmits the prompt sentence and the evaluation context to a generative AI model hosted locally or on a remote inference server. In one embodiment, the generative AI model is implemented as a multi-layer neural network configured for natural language generation. Server provides the prompt sentence and evaluation context as input tokens to a transformer-based architecture including an embedding layer, multiple self-attention layers, feed-forward layers, and an output layer with a softmax function over a vocabulary. Server applies specific configuration parameters such as the number of attention heads, number of layers, hidden dimension size, and dropout rate. The generative AI model has been previously trained on large corpora of text and fine-tuned on domain-specific evaluation documents.

Server, during training operations that may occur in a separate environment, optimizes the generative AI model by minimizing a loss function defined over prediction errors between generated tokens and ground-truth tokens. Server uses gradient-based optimization such as stochastic gradient descent or an adaptive learning method. Server updates model weights using backpropagation, with regularization and early stopping to prevent overfitting. Server may also perform data augmentation by paraphrasing existing evaluation sentences and by injecting structured numeric information into textual training examples, which enables the model to better handle evaluation contexts containing numeric indices and rankings.

Server, during inference, computes attention weights across tokens in the evaluation context and prompt sentence, thereby allowing the generative AI model to focus on relevant indicators and feedback segments. Server configures generation parameters such as temperature and maximum token length to control the style and length of the output. Because the generative AI model internalizes statistical relationships between numeric evaluation indices and associated narrative patterns, the resulting detailed evaluation report information coherently reflects both quantitative and qualitative aspects of the evaluation. This is not a mere automation of human drafting, but a non-conventional use of a trained neural architecture to integrate structured numeric features with free-text narratives, improving consistency and reducing human error in technical data interpretation.

Server receives the generated token sequence from the generative AI model and reconstructs it into natural-language text as detailed evaluation report information. Server may further apply a rule-based post-processor to enforce formatting rules, headings, and terminology constraints. For example, server ensures that sections labeled “Strengths,” “Weaknesses,” and “Development Plan” follow a predefined order and that certain sensitive expressions are suppressed or replaced. This post-processing module uses deterministic parsing and pattern matching algorithms to verify structural integrity of the generated document.

Terminal receives the detailed evaluation report information and displays it to the user. Terminal renders the comprehensive evaluation index, ranking information, and report sections in an integrated view, allowing user to inspect the relationship between numeric scores and narrative conclusions. Terminal may offer filters and controls enabling user to switch between an individual subject view and a group-level view. Terminal may also allow user to edit certain textual portions or to trigger regeneration with a modified prompt sentence.

User interacts with the terminal to request revised reports by altering the focus or granularity of the desired output. For example, user may change a prompt sentence from “Assess promotion potential” to “Provide a technical skill gap analysis for cloud technologies and propose specific courses.” Terminal transmits this modified prompt sentence to the server. Server integrates the modified prompt with the existing evaluation context to produce a new combined input, and the generative AI model generates updated evaluation report information. This iterative workflow is performed without re-computing the underlying metrics unless the evaluation information changes, which avoids unnecessary computation and improves responsiveness.

Server, in a group-level embodiment, computes ability distributions and behavioral characteristic distributions for sets of evaluation subjects. Server uses histogram computations, kernel density estimation, or other statistical aggregation methods to represent how scores are distributed. Server computes temporal change tendencies by comparing distributions across time periods, for example by computing shifts in mean scores and changes in variance. Server embeds these aggregate measures into a set-level evaluation context that the generative AI model uses to produce narrative summaries and training policies. This context includes explicit numerical representations of group-level indicators, which the generative AI model can interpret using its learned mapping between numeric patterns and language expressions.

Server improves computer functioning by structuring evaluation information in a normalized relational schema, by precomputing indices and ranks, and by constructing machine-consumable evaluation contexts for the generative AI model. Because server reduces redundant queries and re-uses precomputed metrics, the overall system achieves faster response times for repeated report generation. Because normalization and weighted aggregation are driven by configuration data, server can modify scoring logic without reimplementing core code, which enhances maintainability and reduces risk of errors when scaling to large organizations.

Server, by automatically embedding numeric features and trend information into prompt sentences, ensures that the generative AI model receives a richer input state than a human draf-ter would typically provide manually. This richer input enables the model to generate more precise and consistent reports, which reflects an improvement in the quality of data utilization and processing in the underlying computer system. The tight integration between the relational data management device, the analysis module, and the generative AI access module yields a coordinated pipeline that minimizes data copying between unrelated applications, thereby reducing memory usage and network overhead.

Server uses non-standard processing sequences that differ from conventional manual or semi-automated workflows. In particular, server first structures heterogeneous evaluation data into unified schemas, then computes subject-level and group-level statistics, then programmatically constructs prompt sentences embedding these statistics, and only then invokes a neural text generation model. This sequence is specifically adapted to the characteristics of the relational database and the generative AI model and is not a generic sequence of storing and displaying data. By designing the pipeline in this manner, the system ensures that the generative AI model always operates on contextually complete and numeric-aware inputs, which leads to reproducible, explainable narrative outputs.

Server can further implement alternative embodiments. In one variation, server uses a different model architecture such as a recurrent neural network with attention mechanisms instead of a transformer, while still combining structured evaluation context and prompt sentences. In another variation, server deploys a smaller generative model on-premises for privacy-sensitive environments, with reduced parameter count and quantized weights to allow efficient inference on edge hardware. In yet another variation, server integrates additional machine learning methods such as clustering algorithms to automatically segment evaluation subjects into groups before constructing set-level evaluation contexts.

Terminal can be implemented in multiple forms. In one embodiment, terminal is a browser-based client running on a general-purpose computer. In another embodiment, terminal is a native application running on a portable device, with local caching for offline viewing of previously generated reports. In some configurations, terminal may display alerts when evaluation indices exceed certain thresholds, and offer quick access to generate targeted reports using predefined prompt sentence templates.

User can utilize the system in various ways. In one use case, user focuses on individual-level performance review, requesting detailed career development plans. In another use case, user focuses on organizational-level analysis, generating training policies for a department or project team. In yet another use case, user iteratively refines prompt sentences to explore different narratives from the same underlying evaluation data, such as a brief summary for executive review and a more technical report for subject-matter experts.

Through these embodiments, server, terminal, and user cooperate to implement an integrated, technically grounded system in which structured evaluation data are acquired, managed, analyzed, and transformed into detailed natural-language reports through a generative AI model, with improved computational efficiency, data integrity, and output consistency compared with conventional manual or loosely coupled systems.

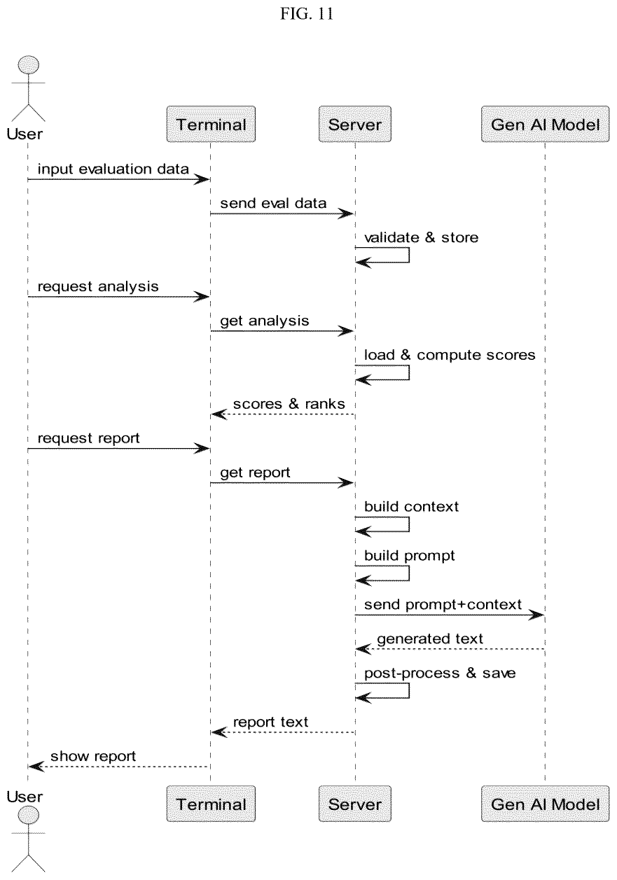

The following describes the processing flow using FIG. 11.

Step 1:

User operates the terminal to input evaluation information.

User selects an evaluation subject and a period on the terminal screen, and enters work results, abilities, and behavioral characteristics, including numeric values (for example, sales amount, achievement rate, number of new clients) and ratings (for example, language skills, technical skills, leadership, communication, teamwork) as well as free-text comments. The input for this step is raw evaluation content provided by the user through form fields and controls on the terminal. The output of this step is a structured payload in the terminal's memory, for example a key-value mapping of all entered indicators and identifiers, ready to be transmitted to the server.

Step 2:

Terminal sends the evaluation information to the server.

Terminal converts the locally stored form data into a structured message, such as a JSON object containing subject identifiers, period identifiers, numeric scores, and comments. Terminal attaches authentication data (such as a session token) and issues a request to the server over a secure network protocol. The input for this step is the structured payload created in Step 1. Terminal performs data serialization and encapsulates the payload in a network message; the output is a network request transmitted to the server containing all evaluation information fields.

Step 3:

Server validates and normalizes the received evaluation information.

Server receives the network request and parses the payload into internal data structures. Server verifies the existence and format of required fields, checks that numeric values fall within allowable ranges, and confirms that subject identifiers and period identifiers correspond to known records in the relational data management device. Server also converts text labels to canonical forms and normalizes date and time fields. The input for this step is the raw payload from the terminal. Server performs validation and type conversion operations, and the output is a sanitized, normalized evaluation information object, or an error response if validation fails.

Step 4:

Server stores the evaluation information in the relational data management device.

Server opens a database transaction and maps each field of the normalized evaluation object to columns in one or more tables such as an evaluation record table and a score detail table. Server generates or retrieves a unique key for the evaluation record, inserts or updates rows in the corresponding tables, and enforces referential integrity via constraints. The input for this step is the normalized evaluation object from Step 3. Server executes insert and update operations, and the output is persistent structured records stored in the relational database, together with a success status that can be returned to the terminal.

Step 5:

Server retrieves stored evaluation information for analysis.

Server receives an analysis request from the terminal specifying a subject set and time period. Server constructs and executes structured queries against the relational data management device to fetch all relevant evaluation records, including raw scores, ratings, and comments. The input for this step is query parameters such as subject IDs, department IDs, and period ranges. Server performs selection and join operations on relational tables, and the output is an in-memory tabular data set containing all indicators needed for further computation.

Step 6:

Server preprocesses and transforms the evaluation data.

Server loads the tabular data set into a data analysis environment and applies preprocessing routines. Server handles missing values by applying a defined strategy (for example, imputation with averages or marking as special codes), performs numerical conversion by mapping categorical labels to numeric codes, and executes scale normalization to bring indicators with different ranges onto a unified 0 -100 scale. The input for this step is the raw tabular data set from Step 5. Server processes each column according to its type and normalization rule, and the output is a cleaned and consistently scaled data set, suitable for subsequent aggregation and scoring.

Step 7:

Server computes comprehensive evaluation indices and ranking information.

Server applies configured weight coefficients to each normalized indicator and calculates weighted sums or weighted averages for each evaluation subject. Server computes additional statistics such as means and variances if required. Server then sorts subjects based on their comprehensive evaluation indices and assigns ranks within the relevant group (for example, department or organization). The input for this step is the normalized data set from Step 6 and a set of weight parameters stored in configuration tables. Server executes vectorized arithmetic operations and sorting algorithms, and the output is a result set that includes, for each subject, a comprehensive evaluation index and a ranking position.

Step 8:

Server stores analysis results back into the relational data management device.

Server formats the comprehensive evaluation indices, ranking information, and any derived metrics (such as percentiles) into records that align with an evaluation result table schema. Server starts a database transaction and writes or updates rows for each subject and period, linking them via foreign keys to the original evaluation records. The input for this step is the computed result set from Step 7. Server carries out insert/update operations and commits the transaction, and the output is a persistent set of evaluation result data that can be retrieved for reporting and prompt construction.

Step 9:

Server constructs an evaluation context for an individual subject.

Server receives a request to generate a detailed report for a particular subject and period. Server retrieves from the relational data management device the subject's comprehensive evaluation index, ranking information, breakdown of indicators, and recent historical scores, along with associated text feedback. Server combines these elements into a structured evaluation context, which may include ordered lists of indicators, trend values (for example, changes compared to previous periods), and representative comments. The input for this step is a subject identifier and a time range. Server performs data retrieval and aggregation operations, and the output is a subject-specific evaluation context object capturing the essential quantitative and qualitative information.

Step 10:

Server constructs an evaluation context for a set of subjects.

Server receives a request for a group-level report for a defined set of subjects, such as members of a team or department. Server retrieves all comprehensive indices, raw scores, and result data for the group and computes group-level statistics, including ability distributions, behavioral characteristic distributions, and temporal change tendencies. Server represents these distributions using aggregated metrics (such as means, variances, and quantiles) and, where useful, discretized bins for histograms. The input for this step is a group definition (for example, department ID) and a time range. Server performs group-by aggregation and statistical calculations, and the output is a set-level evaluation context describing the group's overall performance profile.

Step 11:

Server generates a prompt sentence for an individual report.

Server composes a prompt sentence by combining template text with values from the subject-specific evaluation context. For example, server may generate: “Using the latest evaluation scores and feedback for Employee A, produce a detailed report of strengths, weaknesses, and recommended training courses for the next 12 months,” or “Based on Employee A's total evaluation score, department ranking, and recent trend of improvement, assess the likelihood of promotion within the next evaluation cycle and recommend three specific development actions.” The input for this step is the subject evaluation context and selectable templates stored in configuration. Server performs string formatting and insertion of context-specific values, and the output is a complete prompt sentence tailored to the subject and the requested report type.

Step 12:

Server generates a prompt sentence for a group-level report.

Server composes a prompt sentence that reflects aggregated group information. For instance, server may generate: “Using the evaluation data and feedback for all members of Team C, summarize key strengths, identify common skill gaps, and propose a six-month training and coaching plan to improve overall team performance.” The input for this step is the set-level evaluation context and group-level templates. Server selects a suitable template, integrates group identifiers and time references, and the output is a group-level prompt sentence aligned with the target use case.

Step 13:

Terminal optionally accepts user-edited or user-specified prompt sentences.

Terminal displays a text field showing the automatically generated prompt sentence and allows user to modify it or replace it with a custom instruction. User may refine the focus, for example by changing “promotion potential” to “technical skill development in cloud computing.” The input for this step is the server-generated prompt sentence and the user's keystrokes. Terminal updates its internal representation of the prompt text and the output is a final prompt sentence that will be sent to the server for use with the generative AI model.

Step 14:

Server invokes the generative AI model with the prompt sentence and evaluation context.

Server packages the final prompt sentence together with the corresponding evaluation context (individual or group-level) into an input structure accepted by the generative AI model. Server tokenizes the text, converts tokens to numeric IDs, and submits them to the model's inference endpoint. The input for this step is the final prompt sentence from Step 11, 12, or 13 and the associated evaluation context from Step 9 or 10. Server performs data serialization and network transmission to the model runtime, and the output is a sequence of predicted token IDs representing the generated natural-language report.

Step 15:

Server post-processes the generated detailed evaluation report information.

Server converts the predicted token IDs into text using the model's vocabulary mapping and joins the tokens into sentences and paragraphs. Server applies formatting rules and optional content filters to ensure that required sections such as “Strengths,” “Weaknesses,” and “Development Plan” are present and properly labeled. The input for this step is the raw token sequence returned by the generative AI model. Server performs decoding, segmentation, and rule-based text transformations, and the output is a clean, structured piece of detailed evaluation report information suitable for presentation.

Step 16:

Server stores generated report information for later retrieval.

Server associates the generated detailed evaluation report information with the corresponding subject or group and period and writes it into a report table in the relational data management device. Server stores metadata such as time of generation, prompt sentence used, and reference to the evaluation result data. The input for this step is the finalized report text from Step 15 and reference identifiers. Server executes database insert operations, and the output is a persistent record that can be reloaded without re-running the generative process, improving efficiency for repeated access.

Step 17:

Terminal retrieves and displays the analysis results and report to the user.

Terminal issues a request to the server for the comprehensive evaluation index, ranking information, and any available generated report for the selected subject or group. Terminal receives the structured data and text and renders them visually using tables, charts, and formatted text blocks. The input for this step is the server's response containing indices, ranks, and detailed report text. Terminal performs layout, rendering, and user interface updates, and the output is a combined view that allows user to read both numeric scores and narrative analysis in a coherent presentation.

Step 18:

User reviews, interprets, and optionally triggers regeneration of the report.

User reads the displayed comprehensive evaluation indices, rankings, and narrative report. If user determines that a different emphasis or detail level is required, user edits the prompt sentence in the terminal and instructs the system to regenerate the report. The input for this step is the currently displayed information and the user's revised request. The output is a new command from the user to the terminal, which leads back to the sequence of prompt refinement and generative AI invocation, enabling iterative and data-consistent report refinement.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale operational environments where multiple work objects such as machines, devices, or processes are concurrently executed, conventional computer systems are not able to effectively transform heterogeneous operational data into actionable, real-time control decisions. In particular, existing systems typically perform either simple threshold-based monitoring or static rule-based scheduling, and therefore fail to adapt to dynamic changes in performance, failures, or cooperative behavior among work objects.

First, conventional architectures lack an integrated data processing pipeline that continuously acquires time-series evaluation information from distributed work objects, performs robust preprocessing and feature extraction, and feeds the resulting structured data into advanced inference models. As a result, raw sensor data and status logs are underutilized, and the generated performance indicators are delayed, coarse-grained, or unreliable. This leads to inefficient utilization of computational resources and data storage resources, and prevents the computer system from providing timely and precise control signals to the work objects.

Second, existing machine learning systems for operational optimization are often limited to model inference that produces scores or classifications, without a tightly coupled optimization layer that converts those model outputs into concrete assignment plans for work contents. In many deployments, human operators must manually interpret model results, mentally reconcile them with production plans, and then adjust schedules or task assignments using separate tools. This fragmentation introduces latency, inconsistency, and human error, and prevents the underlying computer from achieving end-to-end automated decision-making.

Third, conventional user support functions based on generative artificial intelligence models typically treat prompt design and context assembly as ad hoc tasks external to the core control system. The prompt sentences lack structured incorporation of the most relevant performance indices, anomaly indicators, and capacity metrics, thereby reducing the quality and specificity of the generated analysis and proposals. Furthermore, user interfaces are not systematically linked to the outputs of generative AI, so that applying or modifying AI-based recommendations requires substantial manual input and domain expertise, limiting the practical impact of such models.

Accordingly, there is a need for a computer-implemented system that improves the functioning of the computer itself by: (i) automatically transforming continuous, multi-dimensional operational data into machine-usable performance indices, (ii) executing an inference model and an optimization program in a coordinated manner to compute assignment plans of work contents, and (iii) programmatically constructing prompt sentences for a generative AI model and integrating the resulting natural language proposals into an interactive user interface for automatic or manual schedule updating. By embedding these capabilities into a single server-side architecture, the computer system can more efficiently utilize computation, memory, and network resources, reduce latency between data acquisition and control actions, and enhance the reliability and transparency of decision-making.

The specific processing by the specific processing unit 290 of the data processing device 12 in Application Example 1 is realized by the following means.

The present invention provides a server comprising a processor configured to acquire evaluation information regarding an operation state of each of a plurality of work objects from an information acquiring device, store the evaluation information in a storage device in association with time-series identification information and object identification information, perform preprocessing and feature generation on the stored evaluation information using a statistical processing program or a learning processing program to calculate performance indices for each work object, execute an inference model configured by the learning processing program using the performance indices as input to generate performance evaluation results and abnormality determination results for each work object, execute an optimization processing program using the performance evaluation results and production plan information as input to calculate an assignment plan of work contents for the work objects, generate work instruction information based on the assignment plan and transmit the work instruction information to the work objects via a communication network, generate a prompt sentence to be input to a generative AI model based on the performance evaluation results and the assignment plan, input the generated prompt sentence to the generative AI model and obtain a natural language expression including an analysis result and proposal information regarding the performance evaluation results and the assignment plan, and generate display information for presenting the analysis result and the proposal information on a user display device. This enables the computer system to implement an end-to-end, machine-executed control loop that efficiently converts low-level operational data into optimized work assignments and human-interpretable recommendations, thereby improving computational efficiency, reducing decision latency, and enhancing the adaptability and transparency of operational control in dynamic environments.

The term “work object” refers to any controllable operational entity, including but not limited to a machine, device, tool, production line, or software-controlled process, whose operation state can be monitored and to which work contents can be assigned.

The term “evaluation information” refers to data representing an operation state of a work object, including, for example, performance metrics, error codes, task completion statuses, throughput values, time durations, and indicators related to cooperative operation with other work objects.

The term “information acquiring device” refers to any hardware or software component configured to obtain evaluation information from a work object, including, for example, a sensor, a controller, a communication interface, or a data collection module.

The term “storage device” refers to a physical or virtual data storage resource, including, for example, a magnetic disk, a solid-state drive, a memory device, or a database system, that is configured to store evaluation information and related data.

The term “time-series identification information” refers to information that uniquely or sequentially identifies a temporal position of evaluation information, such as a timestamp, a time index, or a time interval label.

The term “object identification information” refers to information that uniquely identifies a work object, such as an identifier, a name, a code, or an address associated with the work object.

The term “statistical processing program” refers to software configured to perform numerical analysis, preprocessing, and transformation of evaluation information, including, for example, filtering, aggregation, normalization, outlier detection, and computation of statistical features.

The term “learning processing program” refers to software configured to train or execute a machine learning or artificial intelligence model, including, for example, programs implementing regression, classification, clustering, anomaly detection, or neural network processing.

The term “performance indices” refers to numerical or categorical indicators derived from evaluation information that represent performance characteristics of a work object, such as efficiency scores, failure rates, task completion ratios, utilization levels, and cooperation success rates.

The term “inference model” refers to a model configured by a learning processing program that, when executed, receives performance indices as input and outputs predictions, scores, classifications, or other inferred results regarding the performance or state of a work object.

The term “performance evaluation results” refers to outputs of the inference model that quantify or categorize the performance of a work object, including, for example, performance scores, efficiency levels, or condition ratings.

The term “abnormality determination results” refers to outputs of the inference model or related processing that indicate whether an abnormal state, anomaly, or deviation from expected operation has occurred in a work object.

The term “optimization processing program” refers to software configured to perform an optimization procedure, including, for example, solving a mathematical optimization problem or heuristic search, to compute an assignment plan of work contents based on performance evaluation results and production plan information.

The term “production plan information” refers to data representing desired production objectives and constraints, such as scheduled tasks, required quantities, deadlines, resource constraints, and precedence relations among work contents.

The term “assignment plan” refers to data defining how work contents are allocated to work objects, including, for example, which work object executes which work content, at what time, and under what conditions or priorities.

The term “work contents” refers to units of work or tasks to be executed by a work object, such as jobs, operations, processing steps, inspection actions, or service tasks.

The term “work instruction information” refers to data that specifies control commands or task directives to be transmitted to a work object, including identification of assigned work contents, timing information, parameters, and execution conditions.

The term “communication network” refers to any wired or wireless communication infrastructure that enables data exchange between the server, the work objects, and other components, including, for example, local area networks, industrial networks, and wide area networks.

The term “generative AI model” refers to a machine learning model configured to generate natural language or other structured outputs in response to input data or prompt sentences, including, for example, a large language model trained on textual data.

The term “prompt sentence” refers to a natural language sequence or a structured textual input prepared for the generative AI model, the prompt sentence including contextual information, instructions, or queries that guide generation of an output by the generative AI model.

The term “analysis result” refers to information produced by the generative AI model that interprets, explains, or evaluates the performance evaluation results, the assignment plan, or related operational data in natural language form.

The term “proposal information” refers to information produced by the generative AI model that recommends actions, modifications, or strategies, such as changes to the assignment plan, maintenance suggestions, or operational improvements.

The term “display information” refers to data formatted for presentation on a user display device, including textual descriptions, graphical elements, control items, and layout information that allow a user to view and interact with the analysis result and the proposal information.

The term “user display device” refers to an output apparatus configured to present display information to a user, including, for example, a monitor, a handheld terminal, a tablet, or any other graphical user interface device.

In one embodiment, a server manages operation states of a plurality of work objects, such as industrial machines, automated devices, or software-controlled processes, in a production environment. The server is implemented by a computing platform including at least one central processing unit, a main memory, a non-volatile storage device, and a network interface. The server executes an operating system, a database management system, a data analysis environment, and a machine learning framework. For example, the server executes an operating system such as a general-purpose server operating system, a relational database engine, a programming language runtime, a numerical computation library, a data manipulation library, and a neural network framework.

The server communicates with work objects through an information acquiring device. The information acquiring device includes, for example, one or more controllers attached to the work objects and one or more sensors measuring operational parameters such as cycle time, throughput, vibration, temperature, error codes, and task completion status. The information acquiring device publishes evaluation information over an industrial communication protocol or a message bus. The server receives the evaluation information via the network interface and converts protocol-specific messages into internal data structures stored in the main memory.

The server stores the evaluation information in a storage device as time-series records. Each record includes object identification information that uniquely identifies a work object, time-series identification information such as a timestamp with millisecond resolution, and a set of key-value pairs representing measured or derived attributes. The server organizes the records into tables or collections, for example a “metrics” table with fields such as object_id, timestamp, metric_type, and metric_value, and an “events” table with fields such as object_id, timestamp, event_code, and event_severity. The server maintains indexes on object_id and timestamp to allow efficient retrieval of contiguous time windows for a specific work object. By structuring the data in this way, the server reduces disk seek operations and improves cache locality during analysis.

The server preprocesses the stored evaluation information by executing numerical operations using a numerical computation library and a data manipulation library. The server loads time-series records for each work object into in-memory tabular data structures, applies type casting, and discards records with impossible timestamp orders or inconsistent identifiers. The server performs noise reduction using a moving average filter, interpolates short gaps in sensor readings, and removes outlier values using a rule such as discarding values that are more than three standard deviations away from a rolling mean. The server then derives performance indices, such as average cycle time per fixed time window, mean time between failures, task completion ratio for each shift, and cooperative success rate between pairs of work objects.

The server represents the performance indices as fixed-length numeric vectors for each work object and each time window. For example, the server constructs a feature vector including normalized average cycle time, normalized failure count, normalized completion ratio, normalized idle time ratio, and normalized cooperation error count. The server stores these feature vectors as arrays in a feature store in the storage device. This structured representation enables the server to perform batch predictions and reduces memory overhead compared to operating directly on raw time-series data.

The server executes an inference model implemented as a neural network using a machine learning framework. In one embodiment, the inference model is a feed-forward neural network having an input layer, several hidden layers, and an output layer. Each hidden layer includes a plurality of neurons with activation functions such as rectified linear units. The output layer provides at least two outputs: a continuous performance score and a probability of abnormality. The server loads trained model parameters, including weight matrices and bias vectors, from a model file stored in the storage device into the main memory and, optionally, into a graphics processing unit memory to accelerate matrix multiplications.

The server trains the inference model offline prior to deployment using historical performance data. The server divides historical feature vectors and associated labels (for example, known performance scores and known abnormality labels) into training and validation sets. The server defines a loss function that is a weighted sum of a regression loss, such as mean squared error for performance scores, and a classification loss, such as cross-entropy for abnormality labels. The server optimizes the weights using a gradient-based optimizer such as stochastic gradient descent with momentum or adaptive moment estimation. The server applies regularization techniques such as dropout or L2 weight decay to prevent overfitting. During training, the server performs mini-batch updates, computes gradients, and updates the weights in each iteration until convergence criteria are met. This training procedure improves the predictive accuracy and generalization of the inference model, enabling the server to produce more reliable performance evaluation results.

During operation, the server performs inference by converting recent feature vectors into numeric tensors and feeding them through the neural network. The server computes dot products and applies activation functions in each layer and then outputs performance evaluation results and abnormality determination results for each work object. The server stores these outputs in a separate table in the storage device, including fields such as performance_score, abnormality_probability, and abnormality_flag. By using dense vector representations and optimized matrix computations, the server achieves low latency inference and can evaluate many work objects in parallel, which improves the throughput of the control system.

The server further executes an optimization processing program to compute an assignment plan of work contents. The server retrieves the latest performance evaluation results along with production plan information describing tasks, required completion times, and resource constraints. The server encodes the assignment problem as a mathematical model, for example a mixed-integer programming model, where decision variables represent assignment of tasks to work objects and scheduling times. The server defines an objective function that may minimize total completion time, minimize predicted downtime, or maximize aggregate performance scores. The server imposes constraints such as each task being assigned to a compatible work object, work objects not executing more than one task at the same time, and mandatory maintenance windows being respected.

The server solves the optimization problem using an optimization library that implements algorithms such as branch-and-bound, cutting planes, or local search heuristics. The server utilizes the performance evaluation results to penalize assignments to work objects with high abnormality probability or low performance scores. By integrating model outputs into the optimization objective and constraints, the server produces assignment plans that proactively avoid likely failures and performance degradation. This combination of prediction and optimization leads to assignment plans that are not obtainable by simple rule-based systems and that reduce computational search space by focusing on feasible, high-performing configurations. The server generates work instruction information based on the computed assignment plan. For each work object, the server creates a structured command containing a list of assigned tasks, start times, priorities, and relevant parameters. The server encodes the commands into a protocol-specific message format and transmits the messages to the work objects over the communication network. The work objects then adjust their internal schedules or control parameters according to the received work instruction information. This direct machine-level control causes real changes in physical operations, such as changing which machine performs an assembly task or at what rate a conveyor runs. As a result, the server's internal computations have a concrete effect on the real-world environment, thereby demonstrating a specific technical application beyond abstract data processing.

The server also prepares higher-level explanatory and advisory information for human operators by interacting with a generative AI model. The server generates a prompt sentence that incorporates the performance evaluation results and the assignment plan in a structured manner. For example, the server may construct a prompt sentence as follows:

“The work efficiency of work machine A has decreased by 25% during the last 2 hours. The failure rate has increased from 1% to 4% compared to the last 3 days, and some cooperative tasks with work machine B have failed. Work machine B is currently operating at only 60% of its capacity with a stable task completion rate. Analyze the possible causes of the efficiency decrease of work machine A, and propose an optimal task assignment plan between machines A and B that maintains the overall production volume and minimizes downtime.”

The server programmatically assembles such a prompt sentence by selecting relevant indices (for example, performance degradation amount, failure rate trend, work achievement rate, and unused capacity) and embedding them into predefined template phrases. This non-trivial prompt construction differs from simple logging or report generation because it applies heuristics to select only the most relevant indices, compresses large numeric tables into concise descriptions, and attaches explicit instructions that guide the generative AI model to produce actionable proposals, such as “propose an optimal task assignment plan.”

The server transmits the prompt sentence and, optionally, structured numerical data to the generative AI model via an application programming interface. The generative AI model, which may be implemented as a transformer-based neural network, processes the prompt and generates a natural language expression including an analysis result and proposal information. Internally, the generative AI model applies multi-head self-attention mechanisms and positional encodings to represent the relationships between different parts of the prompt. This architecture allows the generative AI model to combine context about performance indices, assignment constraints, and requested objectives more effectively than traditional rule-based systems.

The server receives the generated natural language expression, parses it if needed, and stores it as proposal information linked to the relevant work objects and time period. The server then produces display information that includes both the system-generated assignment plan and the AI-generated proposals. This display information is formatted as structured user interface components, such as tables showing current assignments, charts of performance scores, and action buttons for applying or modifying recommended changes.

A terminal device operated by a user retrieves the display information from the server via the communication network. The terminal executes a user interface application that renders the display information on a user display device. The terminal highlights abnormal work objects, shows predicted performance degradation, and presents recommended changes in a clear layout. The user can select an option to automatically apply the proposal information, in which case the terminal sends an instruction to the server to update the assignment plan accordingly. Alternatively, the user can manually adjust specific tasks, for example by selecting a task and reassigning it to another work object, and the terminal transmits these modifications back to the server.

The server processes user inputs by updating the assignment plan and regenerating work instruction information. Because the server maintains the full state of evaluation information, feature vectors, model outputs, and assignment decisions, the server can quickly recompute optimized plans that respect both the user's modifications and the latest operational data. This tight feedback loop between computational modules and user interactions reduces the time required to respond to changes in production conditions and reduces the cognitive load on the user.

The described architecture improves computer technology in several ways. First, the server's specific data structures and preprocessing pipeline reduce memory footprint and computation time by converting raw, high-frequency sensor streams into compact feature vectors that are directly suitable for neural network inference and optimization algorithms. Second, the integration of prediction and optimization allows the server to prune the search space and converge on high-quality assignment plans faster than generic schedulers that do not leverage predictive performance information. Third, the prompt construction mechanism uses programmatic selection and aggregation of technical indices to create machine-oriented instructions for the generative AI model, leading to more targeted and reliable recommendations, and thereby reducing the number of iterative requests and the associated communication load. Fourth, the use of a neural network architecture with carefully chosen features and training procedures yields performance evaluation results with lower error rates than threshold-based diagnostics, which directly reduces false alarms and missed anomalies and contributes to more stable operation of the work objects.

The server applies non-conventional procedures that differ from simple automation of human judgment. Instead of directly encoding human rules such as “if failure rate exceeds a threshold, then stop machine,” the server computes multi-dimensional feature vectors, uses a learned inference model to estimate latent performance conditions, and integrates these estimates into a formal optimization problem solved by algorithmic techniques. The server further uses a generative AI model to synthesize explanations and proposals that are conditioned on both statistical evidence and optimization constraints. This combination of machine learning, mathematical optimization, and guided language generation represents a technical solution oriented toward more efficient data processing, better resource utilization, and improved control over complex machine systems.

Various modifications and alternative embodiments are possible. In another embodiment, the inference model is implemented as a recurrent neural network or a temporal convolutional network to better capture temporal dependencies in evaluation information. In another embodiment, the optimization processing program employs constraint programming or meta-heuristic algorithms such as genetic algorithms or simulated annealing. In another embodiment, the server deploys the generative AI model locally rather than via an external service and optimizes prompt sentences to include structured tags that allow the generative AI model to output machine-readable recommendation structures. In yet another embodiment, different subsets of features are chosen for different types of work objects, and the server dynamically selects which inference model to apply based on object type.

In all these embodiments, the server, the terminal, and the user cooperate through the described data structures, algorithms, and interfaces to realize a system that not only automates existing tasks but also enhances the underlying computer operations, improves processing accuracy and speed, and makes it possible to control and optimize complex physical and logical processes in real time.

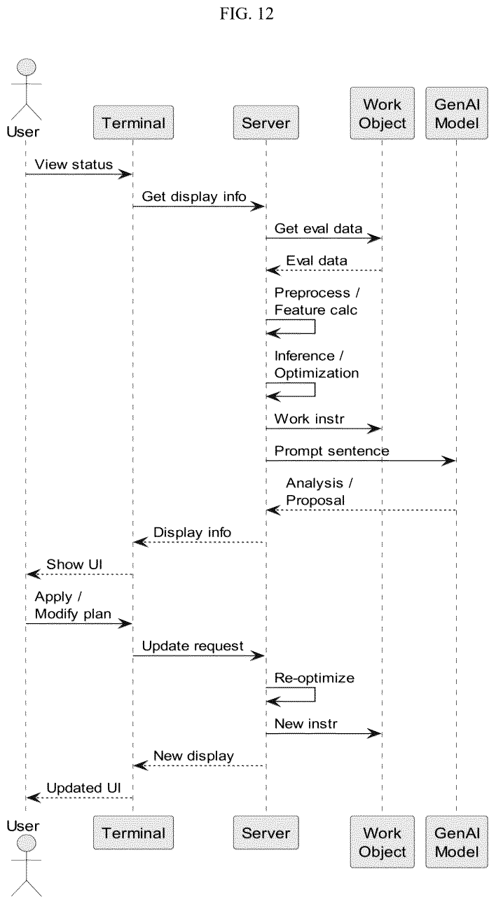

The following describes the processing flow using FIG. 12.

Step 1:

The server acquires raw evaluation information from each work object via an information acquiring device. As input, the server receives device-specific protocol messages containing sensor readings, status flags, and task execution logs. The server parses the messages, extracts fields such as object identifier, timestamp, metric type, and metric value, and converts them into internal records. As output, the server generates normalized evaluation records and stores them temporarily in main memory for further processing.

Step 2:

The server stores the normalized evaluation records in a storage device as time-series data. As input, the server uses the in-memory records produced in Step 1. The server writes each record into a metrics table or collection, attaches time-series identification information (for example, a unified timestamp) and object identification information, and updates indexes on object identifier and timestamp. As output, the server produces a persistent dataset of evaluation information that can be efficiently retrieved by object and time range.

Step 3:

The server preprocesses the stored evaluation information to remove noise and inconsistencies. As input, the server reads time-windowed records for each work object from the storage device. The server performs data type normalization, discards records with invalid timestamps, interpolates short missing intervals, and filters out outlier values using statistical thresholds. The server applies moving averages and smoothing functions to reduce measurement noise. As output, the server produces cleaned, time-aligned datasets for each work object.

Step 4:

The server generates performance indices by transforming the cleaned evaluation information into feature vectors. As input, the server uses the cleaned datasets obtained in Step 3. The server groups records into fixed time windows, computes aggregate statistics such as average cycle time, failure counts, task completion ratios, idle time ratios, and cooperation success rates, and normalizes these values. The server packs the resulting statistics into fixed-length numeric vectors for each work object and time window. As output, the server produces feature vectors that represent performance indices for subsequent model inference.

Step 5:

The server performs performance evaluation and abnormality determination using an inference model. As input, the server feeds the feature vectors produced in Step 4 into a neural network implemented in a machine learning framework. The server executes matrix multiplications and activation functions across the network layers, and computes output values such as a continuous performance score and an abnormality probability for each feature vector. As output, the server generates performance evaluation results and abnormality determination results and stores them in the storage device as model output records linked to the corresponding work objects and time windows.

Step 6:

The server retrieves performance evaluation results and production plan information and computes an assignment plan of work contents. As input, the server uses the model output records from Step 5 and a stored production plan describing tasks, deadlines, and resource constraints. The server formulates a mathematical optimization problem in which decision variables represent assignments of tasks to work objects and scheduling times. The server evaluates an objective function that combines performance scores, predicted abnormality probabilities, and production objectives, and applies an optimization algorithm to find a feasible, near-optimal solution. As output, the server produces an assignment plan specifying which tasks each work object should execute and when.

Step 7:

The server generates work instruction information based on the assignment plan and transmits it to the work objects. As input, the server uses the assignment plan produced in Step 6. The server creates control messages for each work object, including identifiers of assigned tasks, start times, priorities, and configuration parameters. The server encodes these messages according to a communication protocol and sends them through the communication network to controllers of the work objects. As output, the server issues concrete work instructions that cause the work objects to adjust their operational behavior in accordance with the optimized plan.

Step 8:

The server constructs a prompt sentence for a generative AI model by selecting and summarizing relevant performance and assignment data. As input, the server uses performance evaluation results, abnormality determination results, and the assignment plan generated in Steps 5 and 6. The server extracts key indicators, such as performance degradation percentages, failure rate trends, cooperative task error counts, and unused capacity metrics, and inserts these indicators into a predefined language template. The server concatenates a situation description with an explicit instruction to request analysis and recommendations. For example, the server may generate the prompt sentence: “The work efficiency of work machine A has decreased by 25% during the last 2 hours. The failure rate has increased from 1% to 4% compared to the last 3 days, and some cooperative tasks with work machine B have failed. Work machine B is currently operating at only 60% of its capacity with a stable task completion rate. Analyze the possible causes of the efficiency decrease of work machine A, and propose an optimal task assignment plan between machines A and B that maintains the overall production volume and minimizes downtime.” As output, the server produces a structured prompt sentence ready for input to the generative AI model.

Step 9:

The server interacts with the generative AI model to obtain an analysis result and proposal information. As input, the server sends the prompt sentence generated in Step 8, and optionally associated structured metrics, to the generative AI model via an application programming interface. The generative AI model processes the prompt and returns a natural language response containing explanations of potential causes and suggested adjustments to the assignment plan. The server receives the response text, optionally parses sections such as suggested actions or constraints, and associates the response with the relevant work objects and time period. As output, the server produces stored analysis and proposal records suitable for presentation and subsequent control decisions.

Step 10:

The server generates display information for the terminal based on system outputs and generative AI proposals. As input, the server uses the assignment plan from Step 6, the performance evaluation results from Step 5, and the proposal information from Step 9. The server assembles user interface elements, including tables of current tasks per work object, charts of performance scores, status indicators for abnormality, and textual summaries of recommendations. The server formats these elements into a structured response, such as a hierarchical data object describing layout and content. As output, the server provides display information that can be rendered by the terminal as an interactive screen.

Step 11:

The terminal obtains and renders the display information to the user. As input, the terminal receives the structured display information transmitted by the server in Step 10. The terminal parses the content, constructs graphical components such as lists, charts, and buttons, and lays out these components on the user display device. The terminal highlights performance degradation or abnormalities using visual cues and presents the proposal information in readable text blocks. As output, the terminal displays an interactive user interface that allows the user to review current system status and recommended actions.

Step 12:

The user interacts with the terminal to approve, modify, or reject proposed changes to the assignment plan. As input, the user observes the displayed performance data, assignment plan, and proposal information on the terminal screen. The user selects interface controls such as “apply recommendation,” “adjust task,” or “request further analysis,” and provides additional inputs, for example by selecting specific tasks to reassign to different work objects. As output, the user generates control inputs and optional textual comments that the terminal sends to the server as update or query requests.

Step 13:

The server processes user inputs and updates the assignment plan and work instructions as needed. As input, the server receives the user's control commands and any edited task assignments from the terminal in Step 12. The server validates the requested changes against current system constraints, optionally re-runs the optimization processing program with user-specified constraints, and generates an updated assignment plan. The server then regenerates work instruction information and transmits updated control messages to affected work objects, and also refreshes the stored state and display information. As output, the server produces a revised, consistent assignment plan and corresponding work instructions that reflect both automated optimization and user decisions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional employee evaluation support systems and human resource management tools mainly store evaluation data and display static reports. In many cases, the analysis of evaluation information, such as performance scores, capability scores, and behavioral observations, is performed manually or by simple rule-based processing. As a result, the systems have several technical limitations: data preprocessing is ad hoc and inconsistent, statistical and machine learning analyses are not systematically integrated into the processing pipeline, and the generation of input instructions for a generative AI model is left to human operators. These limitations lead to low reproducibility of analysis, inefficient use of computational resources, and difficulty in scaling the solution to large volumes of evaluation data.

Furthermore, existing systems that invoke generative AI models often rely on manually written prompt sentences that are not derived in a structured manner from machine analysis results. Such manual prompts are prone to inconsistency, bias, and omission of important analytical findings. The lack of a programmatically controlled prompt generation mechanism prevents the system from fully exploiting the information contained in the evaluation data and model outputs, and leads to unstable quality of the AI-generated recommendations.

From the perspective of computer technology, there is a need for an improved data processing architecture and control logic that: (i) automatically acquires and preprocesses evaluation information in a structured and repeatable manner; (ii) performs combined statistical, machine learning, and deep learning processing using a processor to derive standardized analysis results including strengths, weaknesses, and importance information; and (iii) automatically converts those analysis results into optimized prompt sentences for a generative AI model. Without such an architecture, the processor cannot reliably transform raw evaluation signals into consistent, high-utility inputs for generative models, and the overall system cannot efficiently generate person-specific, technically grounded proposals at scale.

Accordingly, there is a need for a computer-implemented system and processing method that improve the internal functioning of the data processing pipeline by integrating scheduled extraction, structured preprocessing, multi-method analysis, and dynamic prompt generation and control, so that the processor itself is technically configured to generate, manage, and utilize prompt sentences in a way that optimizes the output of a generative AI model for each individual.

The specific processing by the specific processing unit 290 of the data processing device 12 in Example 2 is realized by the following means.

The present invention provides a server comprising a processor and one or more storage media, the processor being configured to acquire, via an input medium, performance information, capability information, and behavioral information of a person as evaluation information; store the acquired evaluation information as structured information in the storage media; periodically extract, from the storage media, evaluation information that has not yet been processed and perform preprocessing including correction of missing values, normalization of value ranges, and encoding of classification information; execute, on the preprocessed evaluation information, at least one of statistical processing, machine learning processing, and deep learning processing using a multilayer neural network to generate analysis results indicating, for each person, strength information, weakness information, trend information, and importance information of evaluation items; extract, from the analysis results, the strength information, the weakness information, the trend information, and the importance information; automatically generate, by inserting the extracted information into a previously stored text template, a prompt sentence for input to a generative AI model; transmit the generated prompt sentence to the generative AI model via a communication medium and obtain, from the generative AI model, output information including proposal information for supporting career development of the person; and store the obtained proposal information in association with the evaluation information and the analysis results in the storage media and output the proposal information via an output medium. This enables an improved computer-implemented processing pipeline in which the server itself systematically transforms raw evaluation data into normalized features, derives standardized analysis results, and dynamically constructs optimized prompt sentences that control a generative AI model, thereby enhancing the consistency, scalability, and technical effectiveness of AI-generated career development recommendations.

The term “processor” refers to a hardware or virtual computation unit, such as a central processing unit, a microprocessor, or a processing core in a computing device, that executes instructions to perform data acquisition, data processing, control, and communication operations described herein.

The term “input medium” refers to any hardware or software interface through which evaluation information is entered into the system, including but not limited to a graphical user interface, a web interface, a mobile application interface, a keyboard, a pointing device, a touch panel, or an application programming interface.

The term “performance information” refers to data representing quantitative or qualitative results of a person's work activities, such as achievement of targets, productivity indicators, quality metrics, or outcome-based evaluations.

The term “capability information” refers to data representing skills, competencies, or proficiencies of a person in specific domains, including but not limited to technical skills, management skills, communication skills, or problem-solving abilities.

The term “behavioral information” refers to data representing observable behaviors or attitudes of a person in a work or organizational context, such as collaboration, initiative, compliance with rules, or leadership behaviors.

The term “evaluation information” refers to a collection of performance information, capability information, and behavioral information, or a subset thereof, associated with a person and used for assessment or analysis in the system.

The term “storage medium” refers to a physical or logical data storage resource, including but not limited to a magnetic storage device, a solid-state storage device, an optical storage device, a volatile memory device, a non-volatile memory device, or a network-accessible storage system, configured to store evaluation information, analysis results, prompt sentences, and proposal information.

The term “structured information” refers to data organized according to a predetermined schema or format, such as tabular data, records with predefined fields, or data objects with defined attributes, enabling systematic processing by the processor.

The term “preprocessing” refers to a sequence of data transformation operations performed on raw evaluation information prior to analysis, including but not limited to correction of missing values, normalization of value ranges, encoding of categorical attributes, and consistency checking.

The term “correction of missing values” refers to an operation that handles absent or null data entries by discarding incomplete records, substituting estimated values, or otherwise adjusting the data so that subsequent analysis can be performed.

The term “normalization of value ranges” refers to an operation that converts numerical values into a common scale or range, such as by scaling, standardization, or rescaling, to facilitate comparison, aggregation, or model processing.

The term “encoding of classification information” refers to an operation that converts categorical or symbolic attributes, such as roles, departments, or labels, into numerical or machine-readable representations, including but not limited to one-hot encoding or index-based encoding.

The term “statistical processing” refers to computational techniques based on mathematical statistics used to summarize, aggregate, or infer properties of evaluation information, including but not limited to calculation of averages, variances, correlations, or trend indicators.

The term “machine learning processing” refers to computational techniques in which a model is trained or applied to data to perform prediction, classification, clustering, or regression, using algorithms such as decision trees, ensemble methods, or regression models.

The term “deep learning processing” refers to machine learning processing that uses a multilayer neural network or other multi-layered model architectures to learn representations and patterns from data, including nonlinear and high-dimensional relationships.

The term “multilayer neural network” refers to an artificial neural network comprising an input layer, one or more hidden layers, and an output layer, in which each layer contains multiple computational units connected by weighted links that are trained based on data.

The term “analysis results” refers to data objects or records derived from processing evaluation information by statistical processing, machine learning processing, or deep learning processing, including computed indicators and model outputs for each person.

The term “strength information” refers to a portion of the analysis results indicating capabilities, skills, or behaviors of a person that are assessed as relatively strong or above a reference level.

The term “weakness information” refers to a portion of the analysis results indicating capabilities, skills, or behaviors of a person that are assessed as relatively weak or below a reference level.

The term “trend information” refers to a portion of the analysis results indicating changes over time in evaluation information or derived indicators for a person, such as improvement, decline, or stability.

The term “importance information” refers to a portion of the analysis results indicating relative contributions or weights of individual evaluation items or features to an overall evaluation, prediction, or classification, as determined by statistical or machine learning techniques.

The term “text template” refers to a predefined textual pattern or format including fixed text and one or more insertion positions for variable information, used as a basis for generating a prompt sentence.

The term “prompt sentence” refers to a text string that includes instructions, context, and descriptive information derived from analysis results, and that is provided as an input to a generative AI model to control the content and structure of its output.

The term “generative AI model” refers to a computational model, such as a language model or a sequence generation model, that generates new text or other content based on input prompt sentences, using machine learning or deep learning techniques.

The term “communication medium” refers to any wired or wireless communication channel or protocol, including networks and interfaces, through which data, including prompt sentences and output information, is transmitted between the server and external or internal components, including a generative AI model.

The term “output information” refers to data generated by the generative AI model in response to a prompt sentence, including but not limited to text describing proposals, recommendations, or plans.

The term “proposal information” refers to a portion of the output information that includes recommendations or suggestions related to career development, skill improvement, or job capability enhancement for a person.

The term “career development” refers to a process or plan for improving or expanding a person's skills, responsibilities, or employment opportunities over time within an organization or profession.

The term “output medium” refers to a hardware or software interface through which proposal information is presented, including but not limited to a display device, a graphical user interface, a printing device, or an electronic messaging interface.

In one embodiment, a server, a terminal, and a user cooperate to implement the claimed system. The server includes at least one processor, a main memory, a non-volatile storage device, and a network interface. The terminal includes a display unit, one or more input devices, and a communication module. The user operates the terminal to input evaluation information, and the server performs structured preprocessing, multi-method analysis, and prompt sentence generation for a generative AI model.

The server runs a server-side operating system such as a general-purpose server operating system on standard computing hardware including a central processing unit (CPU), a random access memory (RAM) module, and a persistent storage device such as a solid-state drive or a magnetic disk drive. The server executes middleware and application software implemented, for example, using a general-purpose programming language. The server uses a data processing library such as a numerical computation library and a data frame manipulation library for preprocessing, and uses a machine learning library such as a general-purpose machine learning framework and a deep learning framework for analysis. The server stores evaluation information, analysis results, prompt sentences, and generative AI outputs in a relational database management system such as a general-purpose SQL database.

The terminal runs a client operating system such as a mobile operating system or a desktop operating system. The terminal executes a web browser or a native application. The terminal displays input forms for evaluation information, transmits the entered data to the server over a network using a protocol such as HTTPS, and displays analysis-based proposals received from the server.

The user operates the terminal to enter evaluation information for one or more persons. The user inputs performance information, capability information, and behavioral information using graphical user interface components such as text boxes, sliders, dropdown menus, and numeric input fields. The terminal performs local validation to ensure that score values fall within predetermined numeric ranges, that required fields are not left blank, and that text length does not exceed predefined limits. The terminal then assembles the evaluation information into a structured data record and transmits it to the server via a network.

The server stores the received evaluation information in the database as structured rows with fields including a person identifier, an evaluator identifier, timestamps, and multiple evaluation items such as project management, teamwork, and technical skills. The server assigns a processing status field to each record to indicate whether the record has been preprocessed and analyzed. The server also stores metadata such as data source, version of preprocessing rules, and model version identifiers.

The server uses a pre-defined data schema for evaluation information. For example, the server defines a table with columns for numeric scores, categorical attributes such as department and role, and free-text comments. This structure allows the processor to perform deterministic data retrieval and transformation operations, rather than relying on unstructured documents. The use of a normalized relational schema reduces redundancy and improves consistency of stored data, which in turn reduces memory usage and improves query performance.

The server uses a data processing module implemented with a data frame library to perform preprocessing of evaluation information. The server loads unprocessed records from the database into a data frame, and for each column, the server applies predetermined rules. For numeric score columns, the server computes global statistics such as mean and standard deviation and uses these statistics to normalize the values into a standard scale such as zero mean and unit variance, or a fixed [0, 1] range. For categorical columns such as job role or department, the server encodes each category into a numerical feature vector using techniques such as one-hot encoding or ordinal encoding. For missing values, the server applies deterministic imputation rules, for example, replacing missing numeric scores with department-level medians or with model-based imputations. By applying these consistent preprocessing rules, the server reduces variance introduced by ad hoc manual processing and improves the stability and accuracy of downstream machine learning models.

The server uses a machine learning module implemented with a general machine learning library. The server defines a feature vector for each person by concatenating normalized scores and encoded categorical features. The server uses a tree-based ensemble algorithm, such as a random forest model, trained on historical evaluation information and outcome labels (e.g., overall performance rating, promotion decisions, or objective productivity metrics). The server stores trained model parameters such as tree structures, node split thresholds, and feature importance values on the storage device. When the server processes new evaluation information, the server loads the trained model into memory and applies it to the feature vectors to produce outputs including predicted overall performance scores and class probabilities for different performance categories.

The server uses the random forest's feature importance values to compute “importance information” for each evaluation item. The server derives a ranking of skills based on their contribution to the prediction. This ranking is not merely a human-defined weight table but is derived from the model's learned parameters, which reflect complex interactions in the training data. Consequently, the server can identify capability items that are technically important drivers of the model's prediction, which a human evaluator may not easily detect. This contributes to improved precision and interpretability of the analysis results.

The server also uses a deep learning module implemented with a general deep learning framework. In one embodiment, the server defines a multilayer neural network with an input layer corresponding to the feature vector, several hidden layers, and an output layer. Each hidden layer comprises a plurality of units, with nonlinear activation functions such as rectified linear units. The server uses a supervised learning method, such as mini-batch gradient descent with backpropagation, to train the network on historical data. The server uses a loss function such as mean squared error for regression outputs or cross-entropy for classification outputs, and updates weights using an optimizer such as stochastic gradient descent with momentum or adaptive moment estimation. The server may use regularization techniques such as dropout or L2 regularization to prevent overfitting.

The server uses the trained neural network to generate supplementary analysis results such as predicted future performance scores, probabilities of improvement or decline, and nonlinear combinations of capability items. By computing these outputs on preprocessed data, the server leverages the computational efficiency of vectorized operations on a processing unit. This yields faster inference compared to manual or spreadsheet-based methods and allows real-time or near-real-time feedback even when processing large volumes of evaluation records.

The server combines the outputs from statistical analysis, machine learning analysis, and deep learning analysis into unified analysis results for each person. The server computes strength information by identifying capability items whose normalized scores exceed model-based thresholds or organization-wide averages. The server computes weakness information by identifying items whose scores fall below a threshold or whose associated importance is high while the score is low. The server computes trend information by analyzing time series of evaluation scores using statistical techniques, for example, by computing linear regression slopes or moving averages. The server computes importance information by aggregating feature importance metrics from the random forest and sensitivity measures derived from the neural network, such as gradients with respect to input features.

The server then stores these analysis results in structured form in the database, for example, in a separate table linking person identifiers to fields such as “top_strength_skills,” “top_weakness_skills,” “trend_labels,” and “importance_ranking.” This structuring allows the server to perform fast retrieval and aggregation for reporting and prompt generation, and reduces the need for repeated recomputation when generating multiple prompts for the same person.

The server uses a prompt generation module to construct prompt sentences. The server stores one or more text templates that include fixed sentences and placeholder tokens for variable information. For example, a template may include segments such as: “The employee shows strong capabilities in [strength_skills] and relatively weak capabilities in [weakness_skills]. Recent trends indicate [trend_description]. Skills with the highest impact on overall performance are [important_skills]. Based on this information, please propose a development plan.” The server retrieves analysis results from the database and replaces the placeholder tokens with corresponding text fragments derived from the numeric values, such as “project management ability,” “teamwork,” and “technical skills,” along with qualifiers such as “very strong,” “moderate,” or “needs improvement.”

The server uses deterministic rules to map numeric values and importance rankings into linguistic expressions. For example, the server may assign the phrase “very strong” when a normalized score exceeds a first threshold, “strong” when it exceeds a second threshold, and “below average” when below a third threshold. Similarly, the server may describe a skill as “critical for overall performance” when its importance ranking falls within a certain top percentile. These rules ensure that the generated prompt sentence is consistently aligned with the underlying numeric analysis, reducing ambiguity and bias associated with manual description. The server assembles the final prompt sentence as a single text string, which it provides to a generative AI model. For example, the server can generate the following prompt sentence: “Based on the following employee evaluation results, identify the main strengths and weaknesses and generate specific career development suggestions. The employee has very strong project management ability (4.8/5) and good teamwork (4.2/5), but relatively low technical skills (2.5/5), especially in cloud computing and automation. Please propose concrete actions for the next 6 months, including recommended training, on-the-job learning opportunities, and mentoring.”In another example, the server can generate a prompt sentence focusing on long-term planning: “Using the following analysis results for an employee's performance review, generate three concrete career development recommendations. The analysis shows: strong project management, good teamwork, and weak technical skills in cloud computing and automation. Please include both short-term (within 3 months) and long-term (within 1 year) actions.”

In yet another example, the server can generate a prompt sentence emphasizing structured output: “From this employee's evaluation data, identify their top three strengths and top three weaknesses, and propose a personalized development plan. The evaluation items include leadership, communication, project management, teamwork, and technical skills in software development. Structure the output as: strengths, weaknesses, and an actionable 6-month development plan.”

The server transmits the generated prompt sentence to a generative AI model. The generative AI model may be implemented as a large-scale language model with multiple transformer layers, trained on a large corpus of text using unsupervised or semi-supervised learning. The server does not treat the generative AI model as a black box; instead, the server uses the model in a controlled manner, where the prompt sentence encodes structured analysis results and constraints on the output format. Because the server standardizes and optimizes the prompt content based on model-relevant features such as importance information and trend information, the generative AI model operates under well-defined input conditions that improve output relevance and stability. The server receives textual output from the generative AI model and parses the response according to the requested structure. When the prompt sentence requires sectioned output such as “strengths,” “weaknesses,” and “development plan,” the server splits the received text into segments corresponding to these sections. The server may apply additional normalization such as trimming whitespace and checking for prohibited content according to pre-defined rules. The server stores the parsed proposal information in the database, linking it to the corresponding person and evaluation session.

The terminal periodically retrieves the latest proposal information from the server for display. The terminal receives structured response data and renders it into user interface components such as headings and bullet lists. The terminal can also provide user interface mechanisms for the user to accept, modify, or schedule proposed actions, such as enrolling the person in a training course, setting specific learning goals, or assigning mentors. When the user makes such selections, the terminal transmits updated plan information back to the server, which stores it in association with the underlying evaluation and analysis results.

This configuration provides not merely an automation of human tasks but an improvement to computer technology itself. By integrating structured preprocessing, multi-model analysis, and template-based prompt generation in a coherent data flow, the server reduces computational redundancy, improves memory locality, and reduces network traffic. For example, the server avoids repeated computation by storing intermediate normalized features and analysis results, and by generating multiple prompt sentences from a single analysis. The use of feature importance information to dynamically adjust the level of detail in the prompt sentence reduces the volume of text sent to the generative AI model while maintaining or improving the quality of generated recommendations, thereby decreasing network load and inference latency.

Moreover, the server's use of specific algorithms—such as vectorized normalization, tree-based feature importance calculation, gradient-based sensitivity analysis, and rule-based linguistic mapping—creates a non-conventional processing pipeline that yields lower error rates and improved stability compared with systems that rely solely on manual prompts or fixed rule-based text generation. Because the server uses consistent preprocessing and model-based thresholds, the generated prompt sentences encode a more accurate and complete representation of the underlying evaluation information. This in turn leads to more reliable and repeatable outputs from the generative AI model, which is a technical improvement in the overall information processing system.

The server can adopt alternative implementations. In one variation, the server replaces the random forest model with another ensemble method such as gradient boosting while maintaining the computation of feature importance for use in prompt generation. In another variation, the server uses a different deep learning architecture such as a recurrent neural network or a transformer encoder for time-series evaluation data, capturing temporal dependencies more effectively. In yet another variation, the server extends the data schema to include sensor-based measurements such as keystroke dynamics or usage logs of digital tools, and converts those signals into additional features for analysis and inclusion in prompt sentences.

The terminal can also be implemented in different forms. In one embodiment, the terminal is a mobile device with a touchscreen. In another embodiment, the terminal is a desktop workstation with a large display and external input devices. In each case, the terminal's main role is to provide standardized input channels for evaluation information and standardized display channels for proposal information.

The user can operate the system in various organizational contexts, including but not limited to personnel evaluation, skill assessment, and training planning. However, the technical core of the invention resides in how the server acquires, structures, preprocesses, analyzes, and converts data into optimized prompt sentences for a generative AI model, and not merely in the business purpose of those operations. By doing so, the system achieves improved processing speed, improved accuracy of evaluation analysis, reduced error due to manual handling, and reduced network and computation load when interacting with a generative AI model, which constitute technical effects beyond simple automation of human judgment.

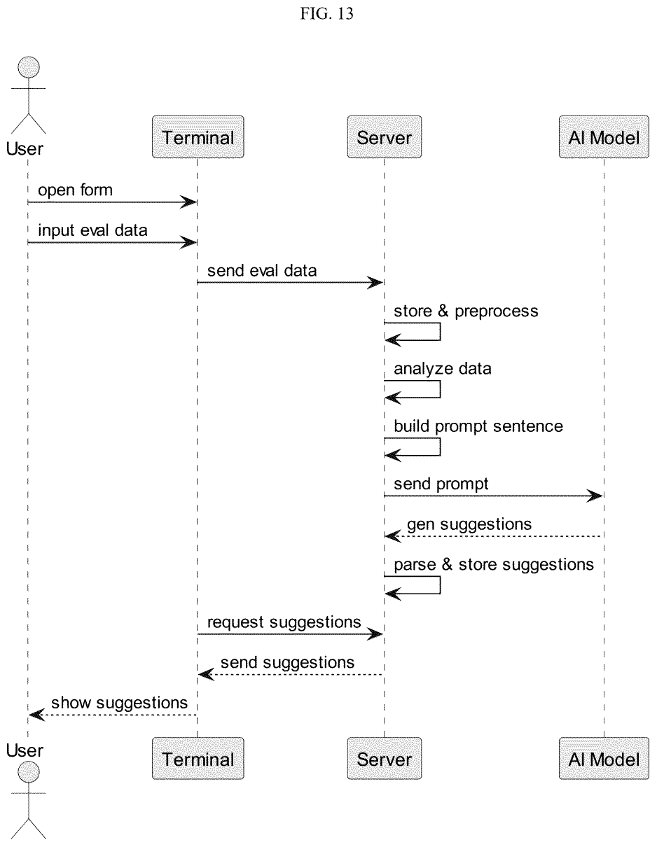

The following describes the processing flow using FIG. 13.

Step 1:

The user operates the terminal to open an evaluation input screen and enters evaluation information for a person, including performance scores, capability scores, behavioral ratings, and optional comments. The input of this step is a blank or previously loaded evaluation form on the terminal, and the output is a completed set of field values on the screen. The terminal validates the entered values (for example, checking that numeric scores fall within a permitted range and that required fields are not empty) and, based on this input, the terminal corrects simple input errors (such as trimming whitespace, converting full-width numerals to half-width) to obtain a clean, structured representation of the evaluation information ready for transmission.

Step 2:

The terminal converts the validated evaluation information into a structured record, for example a key-value map including person identifier, evaluator identifier, timestamps, and multiple evaluation items. The input of this step is the clean set of values entered by the user in Step 1, and the output is a structured data object representing one evaluation instance. The terminal then transmits this structured data object to the server via a secure communication protocol, and by doing so, the terminal encapsulates the evaluation information into a format suitable for server-side parsing and storage.

Step 3:

The server receives the structured evaluation record from the terminal and parses it into internal variables according to a predefined schema. The input of this step is the transmitted structured data object, and the output is a set of internal data structures in main memory, such as field-wise variables and database-bound entities. The server verifies identifiers (e.g., confirms the existence of the person identifier and evaluator identifier), checks type constraints, and, based on this input, generates normalized internal representations (for example, converting date strings into timestamp objects and mapping textual category labels to internal codes) to prepare the data for persistent storage.

Step 4:

The server stores the parsed and validated evaluation information into a relational database table dedicated to evaluation records. The input of this step is the internal data representation from Step 3, and the output is a persistent row (or set of rows) in the database, including a processing status field initially set to “unprocessed.” The server performs a data insertion operation using a database driver and, on the basis of the input fields, it computes and stores additional derived fields such as record creation time and data versioning flags to support later retrieval and traceability.

Step 5:

The server periodically initiates a batch retrieval process to identify evaluation records that have not yet been analyzed. The input of this step is the collection of evaluation records stored in the database, and the output is a subset of records selected by a query condition (for example, where a status column is “unprocessed”). The server executes a database query and, based on the returned records, loads them into an in-memory data structure (such as a table-like array or data frame) that associates each person with a vector of raw evaluation values and attributes.

Step 6:

The server performs preprocessing on the loaded evaluation data to correct missing values, normalize numeric ranges, and encode categorical information. The input of this step is the in-memory collection of raw evaluation records from Step 5, and the output is a feature matrix and associated metadata that represent each record in a numerical, model-ready format. The server calculates summary statistics (means, medians, standard deviations) for relevant fields, replaces missing scores by applying defined rules (such as imputing with department-level medians), rescales scores to a standardized range, and converts categorical attributes into numerical feature vectors using methods such as one-hot encoding. These operations transform heterogeneous input data into a consistent, high-dimensional feature representation that can be processed efficiently by statistical and machine learning algorithms.

Step 7:

The server executes statistical analysis on the preprocessed feature matrix to derive aggregate measures and trends. The input of this step is the normalized evaluation data structure from Step 6, and the output is a set of statistical indicators associated with each person, such as average scores per skill, variance measures, and trend coefficients over time. The server performs computations such as grouping by person identifier and time, computing moving averages or simple linear regressions for each evaluation item, and, based on these computations, assigns trend labels like “improving,” “stable,” or “declining” that will later be incorporated into analysis results.

Step 8:

The server applies a machine learning model, such as a random forest, to the preprocessed features to estimate overall performance and feature importance. The input of this step is the same feature matrix from Step 6, possibly augmented with time-based aggregates from Step 7, and the output is a set of predicted performance scores or classes and a set of importance values for each feature. The server feeds each feature vector into the trained model, collects predictions (e.g., numeric scores or categorical labels), and computes or retrieves internal model metrics such as Gini importance or information gain for each feature. From these inputs and outputs, the server derives importance information for individual evaluation items (for example, project management, teamwork, technical skills) that indicate how strongly each item influences the predicted overall performance.

Step 9:

The server uses a deep learning model, such as a multilayer neural network, to capture non-linear relationships and predict additional evaluation metrics. The input of this step is the feature matrix from Step 6, including normalized scores and encoded categories, and the output is a set of neural network outputs such as predicted future scores or risk probabilities for performance changes. The server feeds each feature vector into the trained network, performs forward propagation across multiple hidden layers, and computes output activations. The server may also compute gradients of outputs with respect to inputs to obtain sensitivity measures for each skill. These computations yield more nuanced analysis results, including interaction effects between skills, which cannot be easily derived using simple linear models.

Step 10:

The server consolidates the outputs of statistical analysis, machine learning analysis, and deep learning analysis into a unified analysis result for each person. The input of this step is the collection of statistical indicators from Step 7, machine learning predictions and feature importances from Step 8, and neural network outputs from Step 9, and the output is a structured record of analysis results per person containing strength information, weakness information, trend information, and importance information. The server compares normalized scores against model-based thresholds, identifies items with high scores and high importance as strengths, and items with low scores and high importance as weaknesses. The server merges trend labels and sensitivity information to create descriptive tags, and stores the consolidated analysis result into an analysis table in the database.

Step 11:

The server retrieves relevant fields from the analysis result table to construct a prompt sentence for a generative AI model. The input of this step is the stored analysis result for a specific person or group of persons, and the output is a set of intermediate textual fragments that describe strengths, weaknesses, trends, and important skills. The server converts numeric scores into qualitative descriptors using predefined mapping rules, selects the top-ranked skills according to importance, and composes short narrative phrases such as “very strong project management ability,” “weak technical skills,” or “improving teamwork trend.” These fragments serve as building blocks for the final prompt sentence.

Step 12:

The server embeds the textual fragments from Step 11 into a predefined text template to generate a complete prompt sentence. The input of this step is the set of narrative fragments and the stored template, and the output is a single coherent prompt sentence tailored for the generative AI model. The server replaces placeholder tokens in the template (such as [strength_skills], [weakness_skills], [trend_description], [important_skills]) with the corresponding phrases, orders the fragments according to importance, and adjusts connective phrases. For example, the server can generate the prompt sentence:

“Based on the following employee evaluation results, identify the main strengths and weaknesses and generate specific career development suggestions. The employee has very strong project management ability (4.8/5) and good teamwork (4.2/5), but relatively low technical skills (2.5/5), especially in cloud computing and automation. Please propose concrete actions for the next 6 months, including recommended training, on-the-job learning opportunities, and mentoring.”

This transformation uses structured analysis output as input and produces a generative-AI-ready instruction text as output.

Step 13:

The server transmits the generated prompt sentence to a generative AI model via a communication interface and receives the model's textual output. The input of this step is the complete prompt sentence from Step 12, and the output is a raw text response that includes recommendations and proposals for career development. The server packages the prompt sentence into a request in a form accepted by the generative AI service, sends the request across the network, and then reads the response body. On the basis of the prompt content and the model configuration (such as temperature or maximum length), the received output typically contains structured narrative sections that the server can further process.

Step 14:

The server parses and normalizes the textual output from the generative AI model into structured proposal information. The input of this step is the raw response text obtained in Step 13, and the output is a structured representation of proposal information, such as lists of recommended actions, time frames, and focus skills. The server identifies section markers or key phrases (for example, “Strengths:”, “Weaknesses:”, “Recommended Actions:”), segments the text accordingly, and removes extraneous markers or formatting. The server then encodes the segments as fields in a database record, which may include short-term and long-term recommendations, specific training programs, suggested on-the-job learning practices, and mentoring plans.

Step 15:

The server stores the structured proposal information into the database and associates it with the corresponding person and the underlying evaluation and analysis records. The input of this step is the parsed proposal structure from Step 14, and the output is one or more database records in a recommendation table, including foreign keys linking to evaluation and analysis tables. The server may also compute summary indicators such as a recommendation timestamp and a model version identifier, and by doing so, the server maintains an auditable history of proposals generated for each person.

Step 16:

The terminal requests the latest proposal information for a selected person and receives the corresponding data from the server. The input of this step is a user selection on the terminal (for example, choosing a person from a list), and the output is a structured response containing the proposal information for that person. The terminal sends a query message to the server, the server retrieves the associated proposal records, and then the server transmits the data back to the terminal in a structured format that can be directly interpreted by the terminal's user interface logic.

Step 17:

The terminal renders the proposal information into a human-readable format on the display and allows the user to interact with it. The input of this step is the structured proposal data received from the server in Step 16, and the output is a visual presentation of strengths, weaknesses, and recommended actions on the terminal screen. The terminal arranges the data into sections such as “Strengths,” “Areas for Improvement,” and “Recommended Development Plan,” and may convert each recommended action into an interactive element (such as buttons or links for “schedule training,” “assign mentor,” or “set goal”). The terminal, based on further user inputs, can send additional instructions back to the server to update or confirm selected actions, thereby closing the loop between analysis, AI-generated proposal, and user-driven decision making.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that support human-resource evaluation, worker training, and factory operation management typically rely on multiple independent subsystems. A first subsystem collects evaluation information such as performance scores and behavior ratings. A second subsystem performs statistical analysis or machine learning on the collected data. A third subsystem may provide rule-based recommendations or static reports. Recently, separate interfaces to generative artificial intelligence models have been introduced, but they are usually operated manually by a human expert who crafts ad hoc prompt sentences and copies results back into local tools.

Such fragmented architectures suffer from several technical problems from the viewpoint of computer technology. First, the data pipeline from heterogeneous acquisition devices (sensors, input terminals, external emotion engines) to analysis engines and then to generative artificial intelligence models is not formally integrated in the system architecture. As a result, each stage performs redundant preprocessing, and data formats must be repeatedly converted on the client side, leading to increased processing latency, unnecessary memory transfers, and higher CPU load.

Second, conventional systems do not automatically generate prompt sentences based on machine-readable intermediate analysis results. In many cases, a human user manually summarizes statistical outputs or model scores and then manually embeds them into a natural-language prompt. This workflow causes a bottleneck at the human-computer boundary, prevents high-frequency re-analysis, and introduces inconsistency and error in how analysis results are translated into instructions for a generative artificial intelligence model. From a technical perspective, the computing system is not exploiting the full potential of its numerical analysis modules, because the communication between deterministic models and generative models is not automated inside the processor.

Third, emotional state information and operational state information are rarely integrated in real time into a unified evaluation pipeline. Existing systems may separately call an emotion recognition engine or an anomaly detection engine, but they do not provide an architectural mechanism in the processor for (i) time-aligning these heterogeneous signals, (ii) computing feature vectors that combine them, (iii) feeding the combined features into machine learning algorithms, and (iv) automatically constructing prompt sentences that include these integrated indicators. This leads to suboptimal use of available sensor and evaluation data and prevents the system from generating context-aware training plans or maintenance proposals.

Fourth, user feedback on the generated proposals (such as approvals, rejections, or modifications) is generally handled outside the core analysis pipeline. In many implementations, feedback is stored in ad hoc logs or spreadsheets and is not fed back into the data preprocessing and model execution stages in a closed loop. Consequently, the computing system cannot programmatically adapt its analysis and its prompt-generation behavior based on actual user decisions, and the overall information processing remains static and inefficient over time.

Therefore, there is a need for an improved computer-based system that, within a single processor-operated architecture, (i) acquires heterogeneous evaluation and operation data, (ii) preprocesses and converts the data into feature vectors, (iii) performs statistical, machine learning, and deep learning analysis including emotion analysis and anomaly detection, (iv) integrates these analysis results into comprehensive indicators, (v) automatically constructs and transmits prompt sentences to a generative artificial intelligence model, (vi) acquires and presents generated text information as structured proposals, and (vii) records user feedback and performs re-analysis. By solving these issues at the level of system architecture and processor-controlled data flows, the invention aims to improve the efficiency, scalability, and consistency of computer-based evaluation, recommendation, and optimization processing.

The specific processing by the specific processing unit 290 of the data processing device 12 in Application Example 2 is realized by the following means.

The present invention provides a server comprising a processor configured to act as an acquisition unit, a storage unit, a preprocessing unit, a feature generation unit, an analysis unit, an emotion analysis unit, an integrated evaluation unit, a prompt generation unit, a generative result acquisition unit, a presentation unit, a feedback acquisition unit, and a re-analysis unit, the acquisition unit being configured to acquire, via detection devices and input devices, performance information, ability information, behavioral evaluation information, emotional state information relating to human workers, and operation information relating to work targets, the storage unit being configured to store the acquired information in a data storage device in association with time-series information, the preprocessing unit being configured to perform data processing including missing-value completion, outlier removal, normalization, standardization, time-series alignment, and attribute integration on the stored information, the feature generation unit being configured to generate, from the preprocessed information, feature vectors including statistical indicators, time-window-based time-series indicators, emotion indicators, and combinations thereof for each human worker and each work target, the analysis unit being configured to apply statistical methods, machine learning algorithms, and deep learning algorithms to the feature vectors to calculate analysis results including tendencies and risks for the human workers and state information for the work targets, the emotion analysis unit being configured to execute an emotion estimation model on image, audio, and language information to calculate emotion indicators and store them in association with the evaluation information, the integrated evaluation unit being configured to integrate the analysis results and the emotion indicators using weighted calculations to generate comprehensive evaluation indicators for the human workers and comprehensive state indicators for the work targets, the prompt generation unit being configured to construct, based on the comprehensive indicators and the analysis results, prompt sentences as instruction sentences to be input to a generative artificial intelligence model and to embed aggregated data relating to the human workers and the work targets into the prompt sentences, the generative result acquisition unit being configured to transmit the prompt sentences to an external generative artificial intelligence model and to acquire text information output from the generative artificial intelligence model, the text information including evaluation reports, capability development plans, work placement proposals, and maintenance plans, the presentation unit being configured to present the acquired text information and the comprehensive evaluation indicators via a user interface on a display device, the feedback acquisition unit being configured to acquire and store operation information representing user responses including approvals, rejections, and modifications with respect to the presented proposals, and the re-analysis unit being configured to re-execute the preprocessing, feature generation, and analysis processing using the stored feedback operation information together with newly acquired evaluation information to generate updated analysis results and updated prompt sentences. This enables the computer system to implement an integrated, closed-loop processing pipeline in which heterogeneous sensor and evaluation data are automatically transformed into feature vectors, analyzed, converted into prompt sentences, consumed by a generative artificial intelligence model, and iteratively refined based on user feedback, thereby improving computational efficiency, reducing manual prompt engineering, enhancing consistency of recommendations, and providing adaptive, context-aware evaluation, training, placement, and maintenance support.

The term “processor” refers to an electronic data processing circuitry, such as a central processing unit or other computation circuitry, that executes instructions to perform the functions of the units described in the present disclosure.

The term “acquisition unit” refers to a functional unit implemented by the processor that obtains data from detection devices and input devices, including performance information, ability information, behavioral evaluation information, emotional state information, and operation information.

The term “storage unit” refers to a functional unit implemented by the processor that writes data to and reads data from one or more data storage devices, and manages association of the data with time-series information or identifiers.

The term “preprocessing unit” refers to a functional unit implemented by the processor that performs data processing operations on raw or stored data, including missing-value completion, outlier removal, normalization, standardization, time-series alignment, and attribute integration.

The term “feature generation unit” refers to a functional unit implemented by the processor that generates feature vectors or feature sets from preprocessed data, including statistical indicators, time-window-based time-series indicators, emotion indicators, and combinations of these indicators.

The term “analysis unit” refers to a functional unit implemented by the processor that applies at least one of statistical methods, machine learning algorithms, and deep learning algorithms to feature vectors to calculate analysis results describing tendencies, risks, and state information.

The term “emotion analysis unit” refers to a functional unit implemented by the processor that executes an emotion estimation model on image information, audio information, or language information to calculate emotion indicators such as joy, anger, sadness, stress level, and motivation level.

The term “integrated evaluation unit” refers to a functional unit implemented by the processor that combines analysis results and emotion indicators, and that generates comprehensive evaluation indicators and comprehensive state indicators by performing weighted calculations or other integration operations.

The term “prompt generation unit” refers to a functional unit implemented by the processor that constructs a prompt sentence, as an instruction sentence, for a generative artificial intelligence model, and that embeds aggregated data or analysis results into the prompt sentence.

The term “generative result acquisition unit” refers to a functional unit implemented by the processor that transmits a prompt sentence to a generative artificial intelligence model and receives text information output by the generative artificial intelligence model.

The term “presentation unit” refers to a functional unit implemented by the processor that controls a user interface to display analysis results, comprehensive indicators, and text information from the generative artificial intelligence model on a display device.

The term “feedback acquisition unit” refers to a functional unit implemented by the processor that acquires operation information representing user responses, including approvals, rejections, and modifications with respect to presented proposals, and stores the operation information as feedback.

The term “re-analysis unit” refers to a functional unit implemented by the processor that re-executes at least part of the preprocessing, feature generation, and analysis processing using newly acquired evaluation information and stored feedback operation information to generate updated analysis results and updated prompt sentences.

The term “detection device” refers to a hardware sensing device, such as a sensor, camera, microphone, or reader, that detects physical quantities or events and outputs corresponding digital signals to the processor.

The term “input device” refers to a hardware interface device, such as a keyboard, pointing device, touch panel, or terminal, that receives user operations or manual entries and outputs corresponding input data to the processor.

The term “data storage device” refers to a physical or logical storage resource, such as a memory device, magnetic storage device, solid-state storage device, or database system, used to store evaluation information, operation information, analysis results, and feedback information.

The term “performance information” refers to data that quantitatively or qualitatively represents results of tasks performed by a human worker, such as productivity, quality metrics, achievement ratios, or output volumes.

The term “ability information” refers to data that represents skills, competencies, or capabilities of a human worker, such as technical skills, language skills, management skills, or other professional abilities.

The term “behavioral evaluation information” refers to data that represents observed behaviors or attitudes of a human worker in a working environment, such as communication, cooperation, problem solving, or compliance with procedures.

The term “emotional state information” refers to data that represents a psychological or emotional state of a human worker, such as levels of joy, anger, sadness, stress, or motivation, derived from sensing or evaluation.

The term “operation information” refers to data that represents states or actions of a work target, such as positions, velocities, accelerations, operating modes, errors, or events observed in equipment or processes.

The term “work target” refers to a physical or logical object being operated or controlled in a working environment, such as machinery, equipment, systems, processes, or other operational entities.

The term “time-series information” refers to data that associates an event or measurement with a time index, such as a timestamp or sequence index, enabling chronological ordering and time-based analysis.

The term “missing-value completion” refers to a data processing operation in which undefined or absent values in a dataset are replaced with estimated or substituted values according to a predetermined rule or model.

The term “outlier removal” refers to a data processing operation by which anomalous data points that deviate beyond a defined threshold or range are excluded, corrected, or otherwise mitigated from a dataset.

The term “normalization” refers to a data transformation operation that scales data values into a standard numerical range or distribution, thereby facilitating numerical stability and comparability.

The term “standardization” refers to a data transformation operation that shifts and scales data values so that they have a desired mean and variance, typically for use in statistical analysis or machine learning.

The term “time-series alignment” refers to a processing operation that adjusts multiple time-dependent datasets so that their time indices are synchronized, thereby enabling coherent time-based comparison or combination.

The term “attribute integration” refers to a processing operation that merges multiple attributes or data fields, possibly from different sources, into a unified representation or record.

The term “feature vector” refers to an ordered set of numerical or categorical values derived from raw or preprocessed data and used as input to statistical methods, machine learning algorithms, or deep learning algorithms.

The term “statistical indicator” refers to a value that summarizes a property of a dataset, such as a mean, median, variance, standard deviation, minimum, maximum, or percentile.

The term “time-window-based time-series indicator” refers to a feature computed from data restricted to a specified time interval, such as averages, counts, or trend measures within a sliding or fixed time window.

The term “emotion indicator” refers to a numerical or categorical representation of an emotional aspect, such as computed scores for joy, anger, sadness, stress level, or motivation level.

The term “statistical method” refers to a mathematical analysis technique, such as regression analysis, clustering, hypothesis testing, or dimensionality reduction, used to derive insights from data.

The term “machine learning algorithm” refers to a computational procedure that learns patterns or relationships from data to perform tasks such as classification, regression, clustering, or anomaly detection.

The term “deep learning algorithm” refers to a machine learning algorithm that uses a neural network having multiple layers to learn complex relationships from large-scale data.

The term “ability tendency” refers to an analysis result indicating a pattern or direction of a human worker's capabilities, such as strengths, weaknesses, or changes over time.

The term “performance tendency” refers to an analysis result indicating a trend or pattern of task performance by a human worker, such as improvement, deterioration, or stability.

The term “turnover risk” refers to an analysis result that estimates the probability or likelihood that a human worker will leave an organization or position.

The term “growth potential” refers to an analysis result representing an estimated capacity of a human worker to improve performance or abilities in the future.

The term “efficiency tendency” refers to an analysis result indicating the degree or pattern of operational efficiency of a work target, such as throughput, utilization, or energy efficiency.

The term “failure sign” refers to an analysis result indicating a precursor or early warning pattern suggesting that a fault or malfunction of a work target may occur.

The term “abnormal state” refers to a condition of a human worker or a work target that deviates from a normal operational pattern beyond defined thresholds or criteria.

The term “placement suitability” refers to an analysis result that indicates the appropriateness of assigning a human worker to a specific role, task, or position, or assigning a work target to a specific location or configuration.

The term “emotion estimation model” refers to a computational model that takes sensor data such as images, audio, or text as input and outputs one or more emotion indicators.

The term “comprehensive evaluation indicator” refers to a score or structured value that integrates multiple types of information, such as performance, ability, behavior, and emotion, to represent an overall evaluation of a human worker.

The term “comprehensive state indicator” refers to a score or structured value that integrates multiple types of information relating to a work target, such as efficiency, abnormalities, and failure signs, to represent an overall operational state.

The term “weighted calculation” refers to a numerical operation in which multiple input values are combined using predefined or learned weights to produce an integrated output value.

The term “prompt sentence” refers to a text sequence that provides instructions and contextual information to a generative artificial intelligence model so that the model produces an output that fulfills a desired task.

The term “generative artificial intelligence model” refers to a machine learning model that generates text or other data in response to an input prompt sentence, based on patterns learned from training data.

The term “evaluation report” refers to text information that describes analysis results and comprehensive evaluations for human workers or work targets in a structured narrative or tabular form.

The term “capability development plan” refers to text information that outlines recommended actions, training, or interventions to enhance capabilities or performance of a human worker.

The term “work placement proposal” refers to text information that suggests assignments or reassignments of human workers to particular roles, tasks, or positions based on analysis results.

The term “maintenance plan” refers to text information that specifies recommended maintenance actions, schedules, or procedures for work targets to prevent or remedy failures.

The term “user interface” refers to a software and hardware combination that enables a user to interact with the system, including input mechanisms and output presentations, such as graphical user interfaces on a display device.

The term “display device” refers to a hardware device that visually presents information to a user, such as a monitor, screen, or panel.

The term “operation information representing a response of the user” refers to data that encodes user actions regarding presented content, including approvals, rejections, modifications, or other interactions.

The term “feedback operation information” refers to stored operation information representing past user responses, which is used as feedback for improving or updating analysis or prompt generation.

In the following embodiments, a “server” denotes an electronic information processing apparatus including at least one processor, a memory, and a storage device, and “a terminal” denotes an information presentation and input apparatus such as a personal computer, a tablet, or a smartphone that communicates with the server over a communication network.

In one embodiment, the server executes a program that implements an acquisition unit, a storage unit, a preprocessing unit, a feature generation unit, an analysis unit, an emotion analysis unit, an integrated evaluation unit, a prompt generation unit, a generative result acquisition unit, a presentation unit, a feedback acquisition unit, and a re-analysis unit, as described in the claims. Server executes the program on a general-purpose operating system such as a server-class operating system and uses a database management system such as a relational database to store and retrieve data. Server uses a data analysis library such as a table-processing library equivalent to Pandas and a numerical computation library equivalent to NumPy for data manipulation and array-based computation. Server uses a machine learning library such as a library equivalent to Scikit-learn and a deep learning framework such as a framework equivalent to TensorFlow or PyTorch to implement statistical methods, machine learning algorithms, and deep learning algorithms. These specific names are exemplary and may be replaced with functionally equivalent software components.

### 1. Hardware and Software Configuration for Data Acquisition and Storage

Server acquires evaluation information relating to human workers and operation information relating to work targets from multiple sources.

Server receives signals from detection devices installed in a working environment, such as cameras, microphones, accelerometers, position sensors, and identification readers, through a wired or wireless communication interface. Server receives these signals over standard communication protocols such as TCP/IP or industrial fieldbus protocols, and converts raw sensor payloads into structured records that include at least a device identifier, a worker identifier or work target identifier, a timestamp, and measurement values.

Server also receives manual inputs via terminals. Terminal displays input screens implemented using a web framework such as a web application framework and runs on a browser or a native application. User operates the terminal to enter performance scores, ability scores, behavioral evaluation values, and comments. Terminal transmits the entered values to the server via a secure HTTP-based application programming interface. Server authenticates and stores the received values within a data storage device such as a relational database.

Server associates all acquired data with time-series information. Server writes evaluation information and operation information into tables where each record contains a primary key, a subject identifier, a timestamp field, and a vector of raw attributes. This explicit storage structure enables time-based alignment during later processing and avoids repeated parsing and transformation at the presentation layer, thereby reducing network overhead and client-side computation.

### 2. Data Preprocessing and Feature Generation

Server preprocesses the stored information using a dedicated preprocessing unit implemented in software. Server loads raw records from the database into in-memory data structures such as columnar tables provided by a data analysis library. Server performs missing-value completion by applying one or more of: constant replacement, neighbor-based interpolation, or model-based imputation. For example, Server may compute the median of a given performance metric per worker and replace missing entries with the median value. This explicit rule reduces the need for ad hoc handling at the application level and stabilizes downstream model behavior.

Server performs outlier removal by calculating statistical thresholds. For each numeric attribute, Server computes a mean and a standard deviation and flags values that exceed a predetermined multiple of the standard deviation as outliers. Server either removes those records or clips the values to a boundary. This operation is executed as vectorized array computations through the numerical computation library and directly improves numerical stability for machine learning training, decreasing the likelihood of overflow or gradient explosion in deep models.

Server normalizes and standardizes feature values. For each feature dimension, Server computes scaling parameters and applies them to raw values, converting them into normalized or standardized values stored in separate fields. This avoids repeated normalization at each model call, reduces redundant computations, and ensures that disparate models (statistical models, machine learning models, and generative AI models) operate on consistent numeric ranges. Server aligns time-series data. When emotion indicators, performance records, and sensor-derived operation measurements are recorded at different sampling rates, Server uses interpolation, resampling, and windowing to align them to a unified time grid. Server stores aligned sequences as fixed-length arrays or as references to time windows. By executing this alignment centrally within the server, the system eliminates inconsistent temporal alignment that might occur if each subsystem performed alignment independently.

Server generates feature vectors. Server aggregates multiple raw attributes into higher-level features, such as:
For a human worker: average performance per time window, variance of task completion time, frequency of high-stress episodes, ratio of tasks completed under high-stress conditions, and trends of performance and stress over rolling windows.
For a work target: average throughput, average downtime per shift, variance of cycle times, frequency of abnormal sensor readings, and patterns of vibration or temperature over time. Server implements these transformations using data analysis functions and stores the resulting feature vectors as multi-dimensional arrays associated with a worker or a work target. The explicit storage of feature vectors in the database, rather than implicit on-the-fly computation at the user interface, reduces CPU load on interactive requests and improves response time when generating new analyses or prompt sentences.

### 3. Machine Learning and Deep Learning Analysis

Server applies statistical methods, machine learning algorithms, and deep learning algorithms to the feature vectors.

In one embodiment, Server implements clustering using a partitioning algorithm such as k-means. Server takes as input a matrix where each row corresponds to a worker feature vector or a work target feature vector and iteratively updates cluster centroids and cluster assignments until convergence. This clustering step identifies groups of workers with similar ability tendencies and emotional states, and groups of work targets with similar operational patterns. Clustering in the server reduces redundancy compared to separate per-user clustering, and allows reuse of cluster results for multiple downstream tasks.

Server implements anomaly detection using an algorithm such as an isolation-based algorithm. Server trains the algorithm on a set of feature vectors representing normal operational conditions and obtains a model that estimates anomaly scores for new vectors. When Server processes recent machine-state vectors, Server detects unusual states with high anomaly scores and generates explicit anomaly markers stored in the database. By converting continuous sensor streams into discrete anomaly events at the server level, the system reduces the amount of data that must be transmitted and processed by terminals, lowering communication and rendering load.

In another embodiment, Server implements a neural network model that processes time-series feature sequences. Server constructs, for example, a deep learning model including:
An input layer that accepts a fixed-length sequence of numeric feature vectors per time step.
One or more recurrent layers, such as long short-term memory layers, configured with a predetermined number of units and activation functions.
Fully connected layers that map the final recurrent outputs to outputs such as predicted performance score, predicted stress level, or predicted failure probability.

Server trains this model in a training phase by minimizing a loss function such as mean squared error for regression targets or cross-entropy for classification targets, using gradient-based optimization. Server updates network weights based on training batches using a method such as stochastic gradient descent with momentum. Server may apply regularization, dropout, or early stopping to prevent overfitting. Server stores trained model parameters in the storage device for use in an inference phase. This explicit description of network structure and training improves the predictability and reproducibility of the model, and allows systematic tuning of hyperparameters to improve accuracy and processing speed.

Server uses the trained model to perform inference on new data. Server passes recent sequences of aligned feature vectors through the neural network, and obtains outputs such as a real-valued growth potential score for a worker or a probability distribution over classes such as “normal operation,” “pre-failure,” and “failure” for a machine. Server stores these outputs as additional fields in the worker or work target records. By running this inference centrally, using vectorized operations and hardware acceleration if available, the system handles large volumes of data more efficiently than manual spreadsheet-based evaluation.

### 4. Emotion Analysis Integration

Server performs emotion analysis using an emotion estimation model. In one embodiment, Server calls an external emotion analysis service that provides functions for facial expression analysis and voice tone analysis. Server sends image frames and audio feature vectors to the service and obtains numeric scores representing joy, anger, sadness, stress level, and motivation level.

Server merges emotion indicators with previously computed features. Server adds emotion scores as additional dimensions within worker feature vectors and recomputes comprehensive evaluation indicators using weighted sums, where each type of information (performance, ability, behavior, emotion) is assigned specific weights that can be configured or learned. By integrating emotion information in the same feature space as other evaluation data, the system produces higher-quality predictions, because models can correlate emotional states with performance outcomes and failure risks. This integration step is implemented with deterministic operations, resulting in replicable and auditable behavior that differs from subjective human judgments.

### 5. Prompt Sentence Construction and Interaction with a Generative AI Model

Server constructs prompt sentences based on analysis results and comprehensive indicators. Server uses a prompt generation unit that formats text templates and inserts selected feature values, trends, and cluster descriptions.

Server, for example, generates a prompt sentence for training recommendation for a worker as follows:

“Using the following skill and performance data for Employee B, analyze strengths and weaknesses and propose a detailed training program for career development. Return a structured summary that includes recommended courses, expected outcomes, and a suggested timeline. Data: performance_score=0.82, communication_skill=high, technical_skill=medium, leadership_skill=low, average_stress_level=0.3, motivation_level=0.8.”

Server constructs this string programmatically by selecting attribute names and values from the feature vectors and comprehensive indicators, and concatenating them according to a defined grammar. Because this construction uses data directly from analysis modules, the system reduces human errors that would occur if a user manually summarized numeric results and typed them into a free-form prompt, thereby improving consistency and reproducibility of generative AI outputs.

Server also generates a prompt sentence for factory operation and maintenance proposal, such as: “Analyze motion data summaries for factory machines and identify efficiency patterns, anomaly indicators, and probable pre-failure states. Propose optimal operation methods and a preventive maintenance schedule for each machine. Data: Machine X: throughput=950 units/day, downtime_ratio=0.12, vibration_pattern=abnormal, temperature_trend=increasing; Machine Y: throughput=1050 units/day, downtime_ratio=0.03, vibration_pattern=normal, temperature_trend=stable.”

Server transmits the prompt sentence to a generative AI model via a programmatic interface using a network protocol such as HTTPS. The generative AI model may be implemented as a large language model deployed on a separate computation infrastructure. Server sends the prompt sentence in a standard format and receives generated text that includes recommendations.

Server does not rely on manual construction of instruction sentences by a human user. Instead, Server automatically selects which attributes to include, how to describe them, and in what order to present them. By embedding structured numeric and categorical data into prompt sentences in a consistent machine-defined manner, the system reduces the variance of generative outputs and makes it feasible to evaluate and optimize the entire pipeline.

### 6. Presentation and Feedback Integration

Terminal displays results and proposals to users. Server transmits to terminals both deterministic analysis results (scores, cluster labels, anomaly flags) and generative AI outputs (evaluation reports, training plans, maintenance proposals). Terminal uses visualization components to render charts, tables, and structured text.

User interacts with the displayed results. User reviews, for example, a training program proposal and selects actions such as “approve,” “modify course sequence,” or “reject.” Terminal sends these responses to the server, specifying the proposal identifier and the type of operation.

Server records feedback as structured data. Server attaches this feedback to the original analysis results and prompt sentences in the database. Server uses this feedback to adjust internal weights and rules. For example, if a particular type of training recommendation is frequently rejected, Server adjusts weighting parameters in integrated evaluation or modifies which features are included in subsequent prompt sentences for that class of workers. This feedback loop constitutes a closed-loop control process that cannot be easily replicated by manual rule maintenance, and it directly enhances technical performance by reducing the generation of irrelevant proposals over time.

### 7. Technical Effects and Improvement of Computer Technology

Server implements the described architecture to improve computer technology in several ways.

First, Server reduces redundant data transformation and network traffic by centralizing preprocessing and feature generation. Instead of terminals or external components repeatedly reformatting raw data, Server holds data in normalized internal structures and provides feature-level interfaces. This reduction in duplicated work leads to lower CPU utilization and shorter response times, especially when many users request analyses simultaneously.

Second, Server improves computational accuracy and stability. By systematically applying missing-value completion, outlier removal, normalization, standardization, and time-series alignment before any model execution, Server prevents numeric instability and inconsistent input conditions that commonly degrade machine learning models when operated piecemeal. This yields more stable model convergence and more accurate predictions compared to naive implementations that operate directly on noisy raw data.

Third, Server improves the efficiency and reliability of integrating deterministic analysis with generative AI outputs. Instead of treating the generative AI model as a separate, manually controlled tool, Server encodes mid-level representations—such as feature vectors and comprehensive indicators—directly into prompt sentences according to deterministic rules. This structured interface reduces human labor for “prompt engineering” and makes the generative AI integration part of the automated computing pipeline. As a result, the system can run frequent, large-scale recommendation cycles that would be impractical with manual prompts.

Fourth, Server exploits AI models not merely to mimic human reasoning but to execute non-intuitive processing pipelines that human operators cannot consistently perform. For example, the neural network model processes hundreds of numerical features across many time steps to detect subtle temporal patterns in worker stress and machine vibration. Human observers cannot interpret such high-dimensional sequences in real time. By designing feature spaces and network architectures tailored to these signals, the system discovers patterns that are specifically useful for predictive maintenance and adaptive training, which directly controls and optimizes operations of physical equipment and human allocation in a way that improves measurable system performance.

Fifth, Server uses feedback signals in a technically meaningful way. Unlike simple logging, the re-analysis unit uses feedback to refine the weighting of features and to refine prompt construction rules. Because feedback is given by structured flags and modification data rather than unstructured comments, Server can update its parameters autonomously. This creates a self-optimizing computing system that improves its own computational performance over time, such as reducing the proportion of rejected proposals and shortening computation time for convergent analyses.

### 8. Variations and Alternative Embodiments

Server may implement alternative data structures, such as a time-series database for operation information and a document database for evaluation narratives, as long as the units can store, retrieve, and process data in the manner described.

Server may use alternative machine learning models. For example, the analysis unit may use tree-based ensemble methods, support vector machines, or graph neural networks to capture relationships among workers or among interconnected work targets. The emotion analysis unit may use convolutional neural networks or transformer-based architectures for image and text analysis. The generative AI model may be replaced by any language-generating model that accepts prompt sentences and outputs text, as long as the prompt generation unit and the generative result acquisition unit can exchange data.

Terminal may be a control panel integrated into industrial machinery. In this case, the presentation unit outputs not only visual information but also control instructions to actuators, based on approved maintenance plans or operation methods. This allows the system to directly influence the operating parameters of work targets such as speed, temperature thresholds, or maintenance intervals, illustrating a concrete control effect beyond abstract data handling.

User may interact with the system via a programmatic interface instead of a graphical user interface. In that case, an external system acts as a user and calls the server's application programming interface to approve or modify proposals, and the feedback acquisition unit records such decisions identically.

The described configuration, with server, terminal, and user as distinct roles, is not limiting. Server functions may be distributed across multiple physical servers or virtual instances for load balancing and redundancy. Terminals may be thin clients running in a browser or fully native applications. The core inventive concept resides in how the server structures and transforms data, uses numerical and deep learning models to derive higher-level indicators, constructs prompt sentences for a generative AI model from those indicators, and integrates user feedback in a closed computational loop to improve future operations.

Through these embodiments and their variations, the system achieves technical effects such as increased processing speed, improved prediction accuracy, reduced manual configuration, lower communication overhead, and more reliable, repeatable integration between deterministic analytic models and generative AI models, resulting in an overall improvement of computer-based evaluation, recommendation, and equipment control technology.

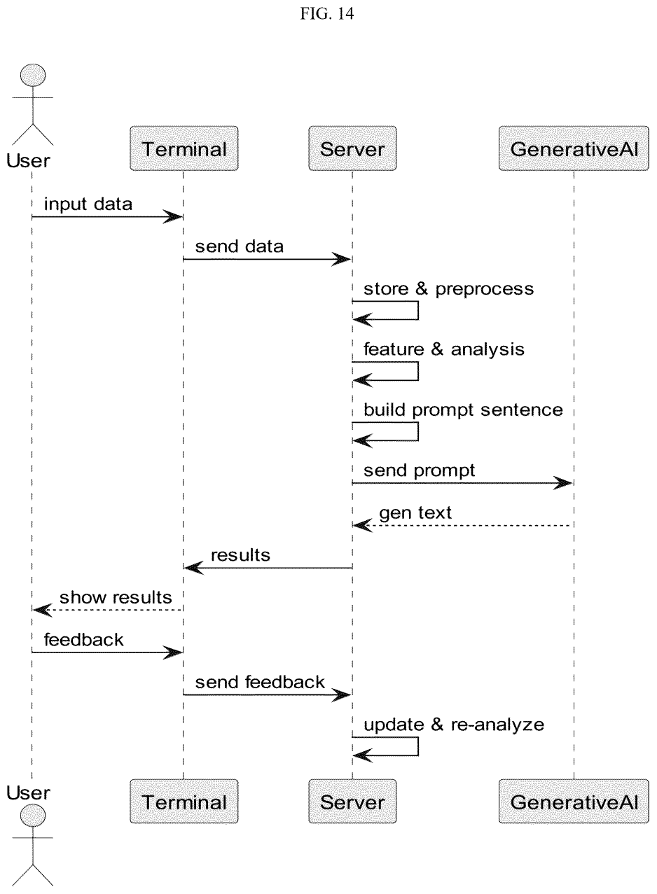

The following describes the processing flow using FIG. 14.

Step 1:

Server acquires raw data from detection devices and terminals.

Server receives, as input, sensor streams from cameras, microphones, motion sensors, and equipment controllers, each stream including device identifiers, timestamps, and measured values.

Server also receives, as input, manual entries from terminals, where User has entered performance scores, ability ratings, behavioral evaluations, and comments through input forms. Server parses these inputs, converts raw payloads into structured records (e.g., tables with fields for subject ID, timestamp, and attributes), and outputs normalized raw data records ready for storage.

Step 2:

Server stores raw data with time-series association.

Server takes as input the normalized raw data records generated in Step 1.

Server writes these records into a data storage device, associating each record with a unique identifier and a timestamp index, and organizes tables by entity type (worker or work target). Server outputs a persistent dataset in which all evaluation information and operation information are stored with explicit time-series structure.

Step 3:

Server preprocesses stored data to clean and normalize values.

Server reads, as input, raw records from the persistent dataset created in Step 2.

Server performs data processing by filling missing values (e.g., replacing null performance scores with per-worker medians), removing outliers (e.g., clipping values beyond a defined standard deviation threshold), and converting categorical labels into numeric codes.

Server also performs data calculation by normalizing and standardizing numeric fields using computed means and standard deviations, and outputs cleaned and scaled records suitable for feature extraction.

Step 4:

Server aligns heterogeneous time-series data.

Server takes as input the cleaned and scaled records for workers and work targets from Step 3, which may be sampled at different intervals.

Server performs data processing by resampling values onto a common time grid (e.g., every minute or every task cycle), interpolating between measurements where needed, and aggregating events into fixed time windows.

Server outputs aligned time-series sequences for each worker and work target, each sequence containing synchronized vectors of performance, behavior, emotion, and operation attributes.

Step 5:

Server generates feature vectors from aligned data.

Server receives, as input, the aligned time-series sequences produced in Step 4.

Server performs data calculation by computing statistical indicators (e.g., mean, variance, min, max), time-window-based indicators (e.g., trend over the last N windows, frequency of abnormal events), and aggregated emotion indicators (e.g., average stress level, maximum motivation level) for each sequence.

Server concatenates these indicators into feature vectors for each worker and work target and outputs a feature matrix in which each row represents one entity and each column represents one computed feature.

Step 6:

Server analyzes feature vectors with statistical and machine learning models.

Server takes as input the feature matrix from Step 5.

Server performs data calculation by executing clustering algorithms (e.g., k-means) to assign each entity to a behavior or operation cluster, by executing classification or regression models (e.g., tree-based models) to predict performance scores or failure risks, and by applying anomaly detection algorithms to compute anomaly scores.

Server outputs analysis results including cluster labels, predicted scores, anomaly flags, and derived metrics for each worker and work target.

Step 7:

Server performs deep learning analysis on temporal patterns.

Server receives, as input, the aligned time-series sequences from Step 4 and, optionally, cluster labels and anomaly flags from Step 6.

Server performs data calculation by feeding these sequences into a trained neural network (e.g., a recurrent model with multiple layers) that computes outputs such as predicted growth potential for workers and predicted pre-failure probabilities for work targets.

Server outputs deep-learning-based prediction vectors and confidence values, which extend the analysis results produced in Step 6.

Step 8:

Server integrates analysis results and emotion indicators into comprehensive indicators.

Server takes as input the outputs from Step 6 and Step 7, and emotion indicators embedded in feature vectors.

Server performs data calculation by applying weighted combination rules to merge performance predictions, ability tendencies, behavior evaluations, emotion scores, and failure risks into a single comprehensive evaluation indicator per worker and a comprehensive state indicator per work target.

Server outputs integrated indicators that summarize multi-dimensional analysis in compact numeric form.

Step 9:

Server constructs structured summaries for prompt generation.

Server receives, as input, the integrated indicators, raw key metrics (e.g., top features per entity), cluster descriptions, and anomaly flags from Step 6-8.

Server performs data processing by selecting a subset of important attributes (e.g., most influential features, dominant clusters, highest risk factors) and formatting them as labeled values (e.g., “performance_score=0.82,” “downtime_ratio=0.12”).

Server outputs structured summaries for each worker and each work target, which are suitable for embedding into natural-language prompt sentences.

Step 10:

Server generates a prompt sentence for a generative AI model.

Server takes as input the structured summaries from Step 9 and a template corresponding to a desired task (e.g., training recommendation or maintenance planning).

Server performs data processing by inserting attribute labels and values into sentence templates, ordering segments according to a predefined grammar, and appending explicit instructions specifying output format and constraints.

Server outputs a prompt sentence, such as:

“Using the following skill and performance data for Employee B, analyze strengths and weaknesses and propose a detailed training program for career development. Return a structured summary that includes recommended courses, expected outcomes, and a suggested timeline. Data: performance_score=0.82, communication_skill=high, technical_skill=medium, leadership_skill=low, average_stress_level=0.3, motivation_level=0.8.”

Step 11:

Server transmits the prompt sentence to a generative AI model and receives generated text.

Server receives, as input, the prompt sentence produced in Step 10.

Server performs data calculation at the communication layer by packaging the prompt into a request payload, sending it via a network protocol to an external generative AI model, and waiting for a response.

Server parses the response, extracts the generated text (e.g., an evaluation report, training program, or maintenance proposal), and outputs this text as structured generative results linked to the corresponding worker or work target.

Step 12:

Server prepares results for presentation to terminals.

Server takes as input the deterministic analysis results and integrated indicators from Step 6-8 and the generative results from Step 11.

Server performs data processing by merging these outputs into response objects, organizing sections such as “Summary,” “Detailed Metrics,” and “Recommended Actions,” and converting numeric indicators into display-friendly formats (e.g., percentages, colored status labels).

Server outputs presentation-ready data packets that contain both numeric analysis and natural-language recommendations.

Step 13:

Terminal requests and displays analysis results and generative recommendations.

Terminal receives, as input, the presentation-ready data packets sent from the server in Step 12. Terminal performs data processing on the client side by mapping fields to user interface components, drawing charts from numeric arrays, and rendering text in appropriate layout regions.

Terminal outputs visual displays on a screen, showing to User the comprehensive evaluation indicators, detailed metrics, and generative AI recommendations for workers and work targets.

Step 14:

User reviews displayed content and provides feedback.

User receives, as input, the visual information shown on the terminal in Step 13.

User performs cognitive evaluation and operates interactive controls (e.g., buttons, selection lists, text fields) to approve, reject, or modify recommended training programs, placement proposals, or maintenance schedules.

User outputs feedback actions through the terminal interface, which are encoded as operation commands (e.g., “approve proposal #123,” “change training start date,” “reject maintenance frequency”) and transmitted to the server.

Step 15:

Server records feedback and updates internal state.

Server takes as input the feedback commands received from the terminal in Step 14.

Server performs data processing by associating each feedback item with the original analysis results, prompt sentence, and generative output, and by storing the feedback as structured records (e.g., decision type, reason, modification parameters).

Server outputs an updated feedback dataset, which is stored alongside evaluation and operation data, and marks proposals with new status values (e.g., approved, rejected, modified).

Step 16:

Server performs re-analysis using new data and accumulated feedback.

Server receives, as input, newly acquired evaluation and operation records as well as the feedback dataset produced in Step 15.

Server performs data calculation by adjusting feature weights, recalibrating thresholds, or updating model parameters according to patterns in historical feedback (e.g., lowering weight of features that correlate with frequently rejected proposals), and then re-executes preprocessing, feature generation, and analysis as in Steps 3-8.

Server outputs updated analysis results, updated integrated indicators, and, when appropriate, updated prompt sentences, which reflect both new raw data and learned user preferences for subsequent interaction with the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

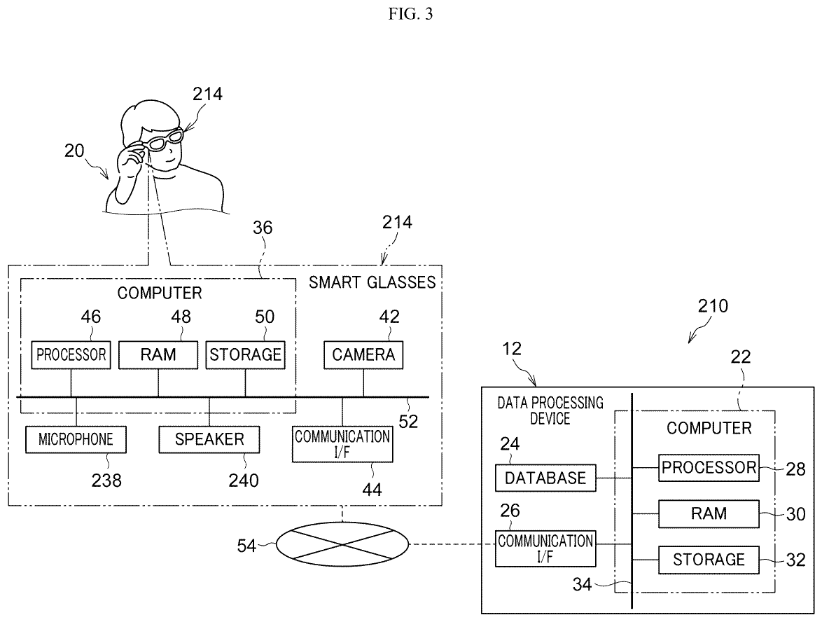

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

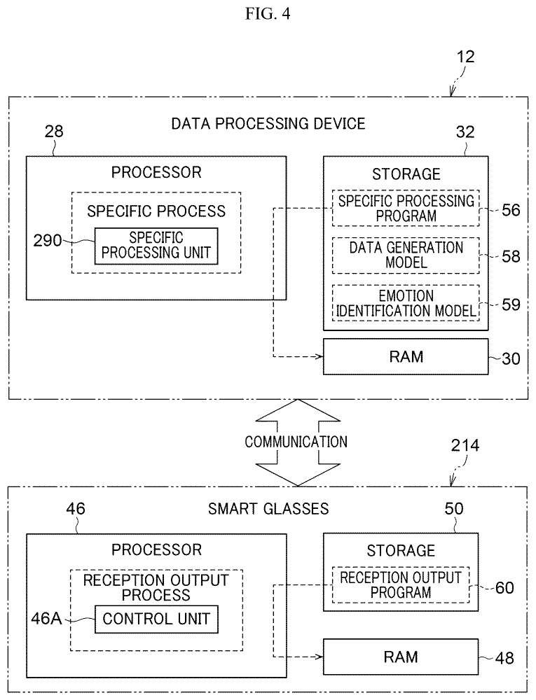

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

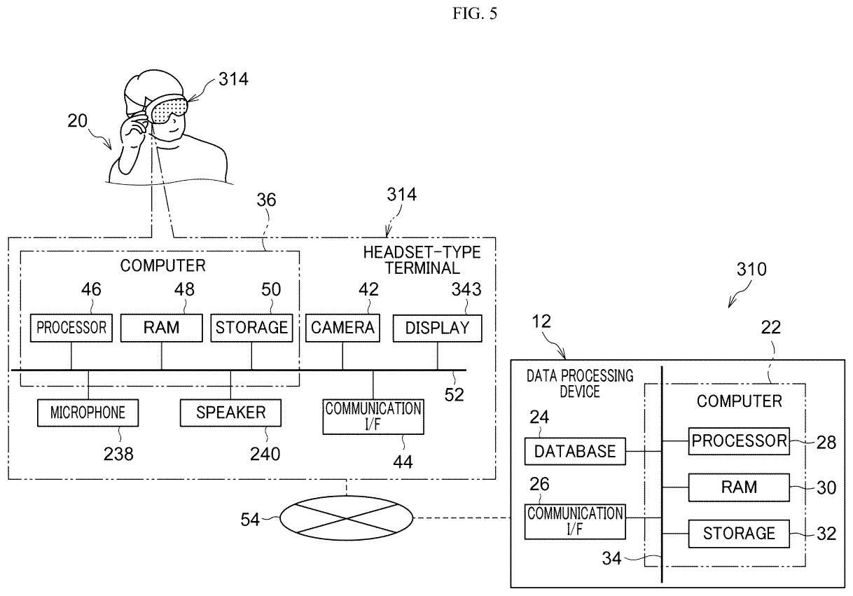

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

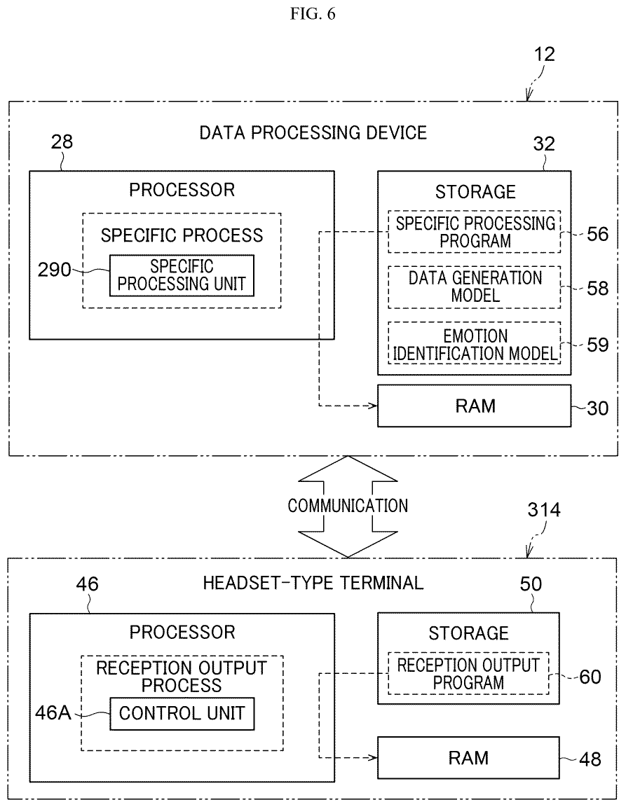

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

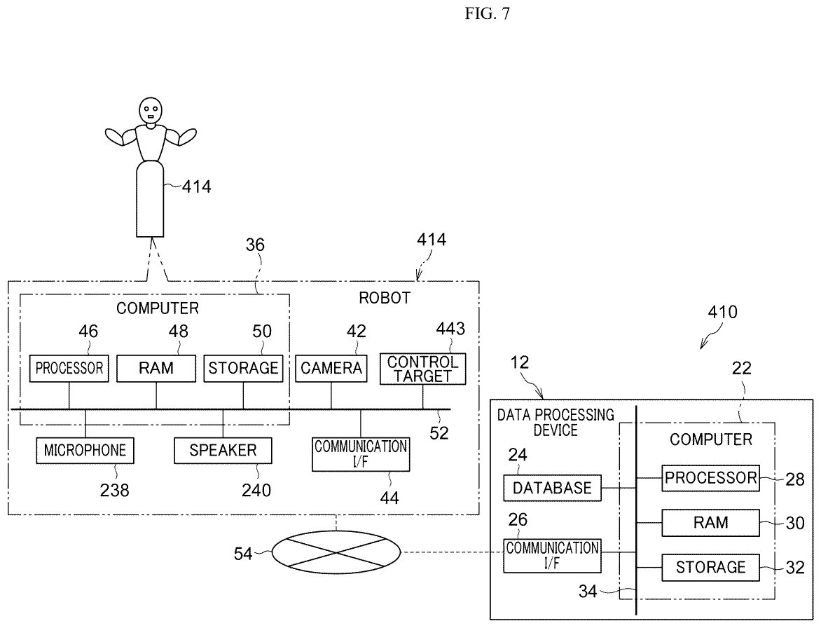

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

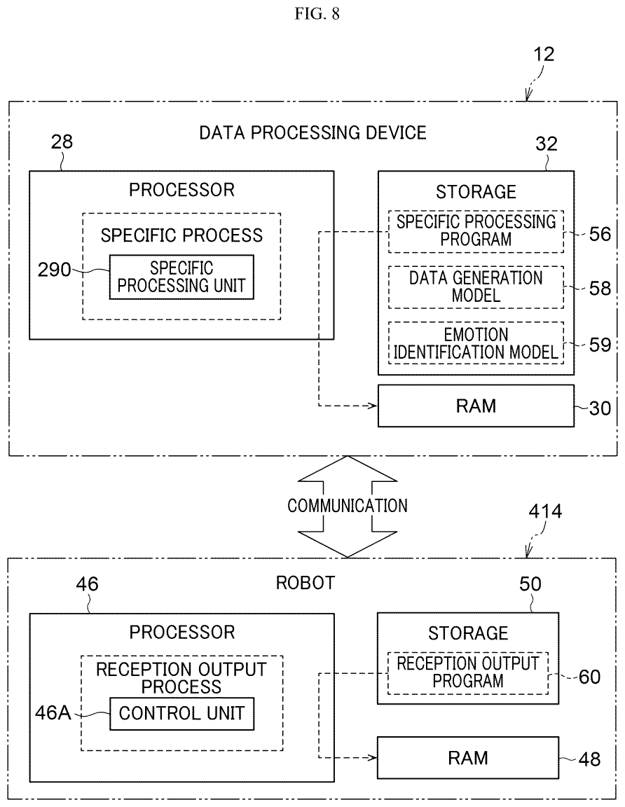

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

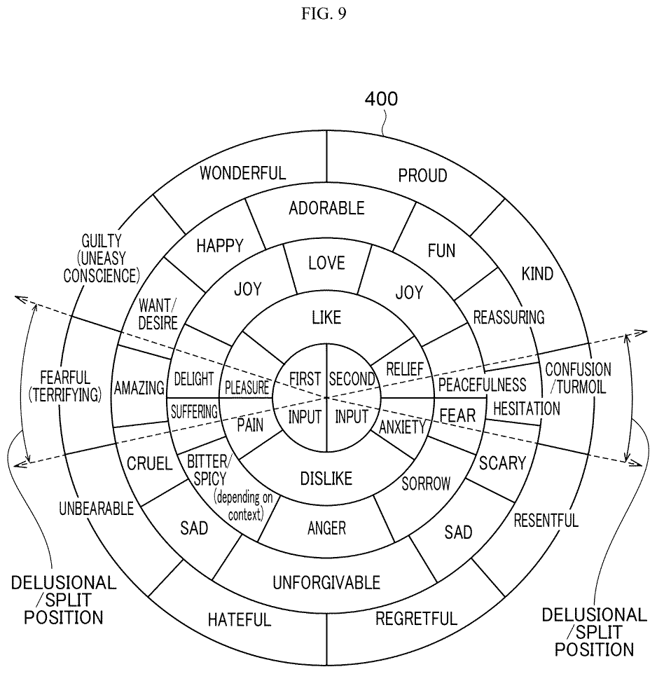

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

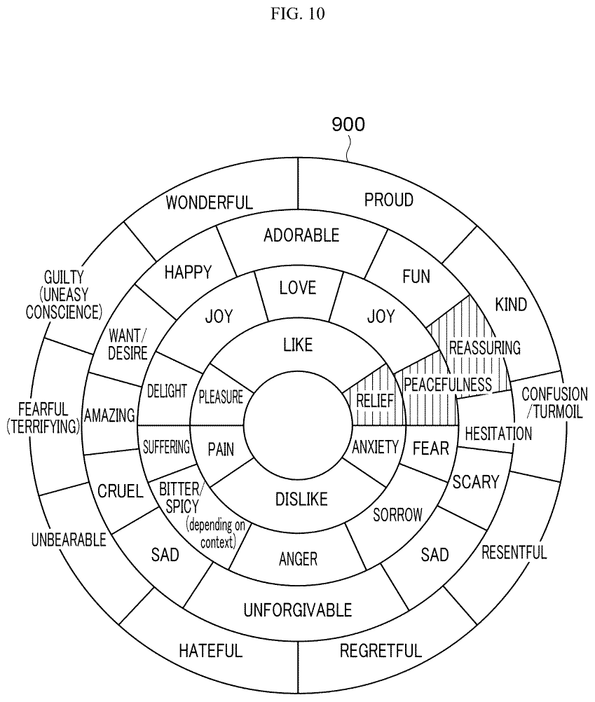

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, via an input component, evaluation information including information related to work results, information related to abilities, and information related to behavioral characteristics of evaluation subjects; and
store, via a communication function and a data management function, the evaluation information as structured data in a relational data management device, and in said storing, logically associate and retain the evaluation information on the basis of identification information and period information; and
obtain, via a computation function and data analysis software, the evaluation information from the relational data management device, and perform preprocessing, numerical conversion, scale normalization, aggregation processing, and weighted calculation on the evaluation information to compute, for each evaluation subject, a comprehensive evaluation index and ranking information, and store the computed comprehensive evaluation index and the ranking information as evaluation result data in the relational data management device; and
generate a prompt sentence, as an instruction sentence to be input to a generative information processing model, the prompt sentence incorporating, in a text format or a structured data format, an evaluation context including at least a part of the evaluation information, the comprehensive evaluation index, and the ranking information; and
transmit the prompt sentence and the evaluation context to the generative information processing model, and acquire, from the generative information processing model, detailed evaluation report information expressed in a natural language; and
output, via a display component, the detailed evaluation report information and the comprehensive evaluation index as display information for a user.

### Supplementary 2

The system according to supplementary 1,
wherein the processor is configured to
compute, via the computation function and the data analysis software, on the basis of the evaluation information and the comprehensive evaluation index, an ability distribution, a behavioral characteristic distribution, and temporal change tendencies within a set of evaluation subjects, construct, at a time of generating the prompt sentence, a set-level evaluation context including the ability distribution, the behavioral characteristic distribution, and the temporal change tendencies, and instruct, using the set-level evaluation context, the generative information processing model to generate evaluation report information related to a training policy or an ability improvement plan for the set of evaluation subjects.

### Supplementary 3

The system according to supplementary 1,
wherein the processor is configured to
cause the display component, in response to an operation input from the user, to display, in an associated manner, contents of the prompt sentence, the comprehensive evaluation index, the ranking information, and the detailed evaluation report information, and, when a change request for the prompt sentence is received from the user, generate a new evaluation context including a changed prompt sentence, retransmit the new evaluation context to the generative information processing model, acquire updated evaluation report information from the generative information processing model, and output the updated evaluation report information as the display information.

### Application Example 1

### Supplementary 1

A system comprising a processor,
wherein the processor is configured to
acquire, from an information acquiring device connected to an information processing device, evaluation information regarding an operation state of a work object,
store the evaluation information in a storage device in association with time-series identification information and object identification information,
perform preprocessing and feature generation on the stored evaluation information using a statistical processing program or a learning processing program, and calculate performance indices for each work object,
execute an inference model configured by the learning processing program using the performance indices as input, and generate performance evaluation results and abnormality determination results for each work object,
execute an optimization processing program using the performance evaluation results and production plan information as input, and calculate an assignment plan of work contents for the work objects,
generate work instruction information based on the assignment plan and transmit the work instruction information to the work objects via a communication network,
generate a prompt sentence to be input to a generative AI model based on the performance evaluation results and the assignment plan,
input the generated prompt sentence to the generative AI model and obtain a natural language expression including an analysis result and proposal information regarding the performance evaluation results and the assignment plan, and
generate display information for presenting the analysis result and the proposal information on a user display device.

### Supplementary 2

The system according to supplementary 1,
wherein the processor is configured to
cause a prompt sentence generation function to construct the prompt sentence so as to include a situation description comprising at least a performance degradation amount in the performance evaluation results, a failure occurrence trend, a work achievement rate, an index relating to cooperative work, and an index relating to unused capacity, and an instruction sentence requesting a proposal of a reallocation policy of work contents among the work objects.

### Supplementary 3

The system according to supplementary 1,
wherein the processor is configured to
cause a display information generation function to generate user operation screen information including an operation item for automatically updating the assignment plan based on the proposal information obtained from the generative AI model and an operation item for manually modifying the assignment plan.

### Example 2

### Supplementary 1

A system comprising a processor,
wherein the processor is configured to
acquire, via an input medium, performance information, capability information, and behavioral information of a person as evaluation information,
store the acquired evaluation information as structured information in a storage medium, periodically extract, from the storage medium, evaluation information that has not yet been processed and perform preprocessing including correction of missing values, normalization of value ranges, and encoding of classification information,
execute at least one of statistical processing, machine learning processing, and deep learning processing using a multilayer neural network on the preprocessed evaluation information to generate analysis results indicating, for each person, strength information, weakness information, trend information, and importance information of evaluation items,
extract, from the analysis results, the strength information, the weakness information, the trend information, and the importance information, and automatically generate a prompt sentence for input to a generative AI model by inserting the extracted information into a previously stored text template,
transmit the generated prompt sentence to the generative AI model via a communication medium and obtain, from the generative AI model, output information including proposal information for supporting career development of the person, and
store the obtained proposal information in association with the evaluation information and the analysis results in the storage medium and output the proposal information via an output medium.

### Supplementary 2

The system according to supplementary 1,
wherein the processor is configured to
control the prompt sentence such that the proposal information is constituted as a concrete action plan including at least one of an educational activity, an on-the-job learning activity, and a guidance activity for improving a job capability of the person, by incorporating period information and implementation-form information into the prompt sentence.

### Supplementary 3

The system according to supplementary 1,
wherein the processor is configured to
use the importance information of each capability item in the analysis results to dynamically change an order of description, a degree of emphasis, and a level of detail within the prompt sentence so as to optimize contents of the output information generated by the generative AI model for each person.

### Application Example 2

### Supplementary 1

A system comprising a processor,
wherein the processor is configured to function as an acquisition unit, a storage unit, a preprocessing unit, a feature generation unit, an analysis unit, an emotion analysis unit, an integrated evaluation unit, a prompt generation unit, a generative result acquisition unit, a presentation unit, a feedback acquisition unit, and a re-analysis unit, and
wherein the acquisition unit is configured to acquire, by using a detection device or an input device, performance information, ability information, behavioral evaluation information, emotional state information relating to a human worker, and operation information relating to a work target, and
wherein the storage unit is configured to store, in a data storage device, the acquired evaluation information and the operation information in association with time-series information, and wherein the preprocessing unit is configured to perform data processing including missing-value completion, outlier removal, normalization, standardization, time-series alignment, and attribute integration on the evaluation information and the operation information stored by the storage unit, and
wherein the feature generation unit is configured to generate, based on the evaluation information and the operation information processed by the preprocessing unit, feature vectors including statistical indicators for each human worker and each work target, time-window-based time-series indicators, emotion indicators, and combinations thereof, and
wherein the analysis unit is configured to apply at least one of a statistical method, a machine learning algorithm, and a deep learning algorithm to the feature vectors generated by the feature generation unit, and to calculate analysis results including at least one of an ability tendency, a performance tendency, a turnover risk, a growth potential of each human worker, and an efficiency tendency, a failure sign, an abnormal state, and a placement suitability of each work target, and
wherein the emotion analysis unit is configured to execute an emotion estimation model using at least one of image information, audio information, and language information as input, and to calculate emotion indicators including at least joy, anger, sadness, stress level, and motivation level for each human worker, and to store the emotion indicators in association with the evaluation information, and
wherein the integrated evaluation unit is configured to integrate the analysis results calculated by the analysis unit and the emotion indicators calculated by the emotion analysis unit, and to generate, by weighted calculation, a comprehensive evaluation indicator for each human worker and a comprehensive state indicator for each work target, and
wherein the prompt generation unit is configured to construct, based on the comprehensive evaluation indicators, the analysis results, and the comprehensive state indicators, a prompt sentence that is an instruction sentence to be input to a generative artificial intelligence model, and to include aggregated data relating to the human workers and the work targets in the prompt sentence, and
wherein the generative result acquisition unit is configured to transmit the prompt sentence to an external generative artificial intelligence model and to acquire text information output from the generative artificial intelligence model, the text information including at least one of an evaluation report, a capability development plan, a work placement proposal, and a maintenance plan, and
wherein the presentation unit is configured to present, via a user interface, the text information acquired by the generative result acquisition unit and the comprehensive evaluation indicators generated by the integrated evaluation unit on a display device for a user, and
wherein the feedback acquisition unit is configured to acquire operation information representing a response of the user, the response including at least one of approval, rejection, and modification with respect to a proposal content presented by the presentation unit, and to store the operation information as history in the data storage device, and
wherein the re-analysis unit is configured to perform again processing by the preprocessing unit, the feature generation unit, and the analysis unit using the operation information acquired by the feedback acquisition unit and newly acquired evaluation information, and to generate updated analysis results and an updated prompt sentence.

### Supplementary 2

The system according to supplementary 1,
wherein the processor is configured to cause the prompt generation unit to generate, based on the comprehensive evaluation indicators for the human workers generated by the integrated evaluation unit and the ability tendencies, the growth potentials, and the emotion indicators calculated by the analysis unit and the emotion analysis unit, a prompt sentence that instructs the generative artificial intelligence model to propose an educational plan for improvement of capabilities of the human workers, and to cause the generative result acquisition unit to input the prompt sentence to the generative artificial intelligence model so that an educational program including a type of educational content, a difficulty level, an execution order, and an execution period is generated.

### Supplementary 3

The system according to supplementary 1,
wherein the processor is configured to cause the prompt generation unit to generate, based on the operation feature vectors of the work targets generated by the feature generation unit and the efficiency tendencies, the abnormal states, and the failure signs calculated by the analysis unit, a prompt sentence that instructs the generative artificial intelligence model to propose an operation method and a maintenance plan for the work targets, and to cause the generative result acquisition unit to input the prompt sentence to the generative artificial intelligence model so that proposal information including at least an arrangement plan of the human workers, an improvement plan of operation procedures, and a maintenance schedule is generated, and to cause the presentation unit to display the proposal information on the display device for the user.

What is claimed is:

1. A system comprising:
circuitry configured to
receive, via a packet-switched network, a plurality of structured data records from a terminal device, each structured data record of the plurality of structured data records comprising numerical indicator data and categorical attribute data associated with an entity identifier and a temporal period identifier;
store the plurality of structured data records in a relational data management device by mapping each structured data record to one or more table entries indexed by the entity identifier and the temporal period identifier;
retrieve, from the relational data management device, a subset of the plurality of structured data records matching a query condition specifying at least one entity identifier and at least one temporal period identifier;
apply, to the retrieved subset, a normalization operation that converts heterogeneous scale ranges of the numerical indicator data into a unified numerical scale to generate normalized indicator data;
compute, based on the normalized indicator data and a set of weight coefficient values, a composite index value for each entity identifier by performing a weighted aggregation operation, and determine a rank position value for each entity identifier relative to other entity identifiers within a defined grouping condition;
generate a structured input sequence for a generative neural network model, the structured input sequence encoding at least a portion of the normalized indicator data, the composite index value, the rank position value, and an instruction character sequence specifying a generation task;
input the structured input sequence to the generative neural network model to obtain output character sequence data representing inference data generated by the generative neural network model; and
transmit, via the packet-switched network, the output character sequence data and the composite index value to the terminal device for rendering on a display of the terminal device.

2. The system according to claim 1, wherein the circuitry is further configured to, prior to applying the normalization operation, perform a validation operation on the retrieved subset that verifies format conformance and value range conformance of the numerical indicator data, and replace non-conforming data entries with imputed values computed from remaining conforming data entries.

3. The system according to claim 2, wherein the normalization operation comprises mapping each numerical indicator value to a value within a predefined bounded range by applying a linear scaling function based on a minimum value and a maximum value determined from the retrieved subset.

4. The system according to claim 3, wherein the plurality of structured data records comprise performance metric data representing quantitative work output indicators, competency rating data representing assessed ability levels across a plurality of skill categories, and behavioral assessment data representing observed conduct characteristics of evaluation subjects within an organizational unit.

5. The system according to claim 4, wherein the composite index value is computed by multiplying each normalized indicator value by a corresponding weight coefficient value retrieved from a configuration table stored in the relational data management device, and summing the weighted values to produce a single scalar composite index value for each evaluation subject.

6. The system according to claim 1, wherein the generative neural network model comprises a transformer-based language model having an embedding layer that maps input token identifiers to multidimensional vector representations, a plurality of self-attention layers that compute attention weight distributions over the vector representations, and a feed-forward output layer that generates a probability distribution over a vocabulary of token identifiers.

7. The system according to claim 6, wherein the structured input sequence further encodes a template instruction portion and a context data portion, the template instruction portion specifying a report structure comprising a plurality of section identifiers, and the context data portion comprising serialized representations of the normalized indicator data and the composite index value.

8. The system according to claim 7, wherein the circuitry is further configured to post-process the output character sequence data by segmenting the output character sequence data into a plurality of labeled text sections corresponding to the plurality of section identifiers specified in the template instruction portion.

9. The system according to claim 8, wherein the plurality of labeled text sections comprise a strengths analysis section, a development needs section, and a recommended action items section for each evaluation subject, and wherein each labeled text section references specific numerical indicator values from the normalized indicator data.

10. The system according to claim 1, wherein the circuitry is further configured to:
retrieve, from the relational data management device, a set of structured data records associated with a plurality of entity identifiers sharing a common grouping attribute value;
compute group-level statistical measures comprising a mean value, a variance value, and a distribution histogram over the composite index values of the plurality of entity identifiers; and
generate a second structured input sequence for the generative neural network model encoding the group-level statistical measures and a second instruction character sequence specifying generation of a group-level summary.

11. The system according to claim 10, wherein the group-level statistical measures further comprise an ability distribution profile and a behavioral characteristic distribution profile computed across the plurality of entity identifiers, and wherein the second structured input sequence encodes discretized bin values representing the ability distribution profile.

12. The system according to claim 11, wherein the group-level summary comprises a team performance analysis, a common skill gap identification, and a proposed group development plan generated by the generative neural network model based on the group-level statistical measures.

13. The system according to claim 1, wherein the circuitry is further configured to:
receive, via the packet-switched network, a modified instruction character sequence from the terminal device, the modified instruction character sequence representing an edited version of the instruction character sequence;
generate a revised structured input sequence encoding the modified instruction character sequence and the at least a portion of the normalized indicator data; and
input the revised structured input sequence to the generative neural network model to obtain revised output character sequence data.

14. The system according to claim 13, wherein the circuitry is further configured to store, in the relational data management device, association data linking the revised output character sequence data with the modified instruction character sequence and the composite index value, thereby maintaining a traceable correspondence between generated output data and input parameters.

15. The system according to claim 1, wherein the circuitry is further configured to compute, for each entity identifier, a temporal trend value by comparing composite index values across a plurality of temporal period identifiers, and to include the temporal trend value in the structured input sequence.

16. The system according to claim 15, wherein the temporal trend value indicates a rate of change of the composite index value over successive temporal periods, and wherein the structured input sequence further encodes a historical comparison data portion comprising composite index values from at least two prior temporal period identifiers.

17. The system according to claim 16, wherein the circuitry is further configured to generate, based on the temporal trend value and the historical comparison data portion, a predictive indicator representing an estimated future composite index value for the entity identifier, and wherein the instruction character sequence specifies generation of a forward-looking development recommendation based on the predictive indicator.

18. A system comprising:
circuitry configured to
receive, via a packet-switched network, a plurality of structured data records from a terminal device, each structured data record comprising numerical indicator data and categorical attribute data associated with an entity identifier;
store the plurality of structured data records as table entries in a relational data management device indexed by the entity identifier and a temporal period identifier;
retrieve a subset of the plurality of structured data records from the relational data management device based on a query condition, and apply a validation operation that verifies value range conformance and replaces non-conforming entries with imputed values;
apply a normalization operation to the validated subset to map heterogeneous numerical indicator data to a unified bounded numerical scale, generating normalized indicator data;
compute, based on the normalized indicator data and weight coefficient values stored in a configuration table of the relational data management device, a composite index value for each entity identifier by performing a weighted aggregation, and determine a rank position value for each entity identifier within a grouping defined by a common attribute value;
compute a temporal trend value for each entity identifier by comparing composite index values across a plurality of temporal period identifiers;
generate a structured input sequence for a generative neural network model, the structured input sequence encoding the normalized indicator data, the composite index value, the rank position value, the temporal trend value, and an instruction character sequence specifying a generation task with a defined report structure comprising a plurality of section identifiers;
input the structured input sequence to the generative neural network model to obtain output character sequence data;
segment the output character sequence data into a plurality of labeled text sections corresponding to the plurality of section identifiers; and
transmit, via the packet-switched network, the plurality of labeled text sections and the composite index value to the terminal device for rendering on a display of the terminal device.

19. The system according to claim 18, wherein the circuitry is further configured to receive, from the terminal device via the packet-switched network, a modified instruction character sequence, generate a revised structured input sequence encoding the modified instruction character sequence and the normalized indicator data, input the revised structured input sequence to the generative neural network model to obtain revised output character sequence data, and store association data in the relational data management device linking the revised output character sequence data with the modified instruction character sequence.

20. A method comprising:
receiving, via a packet-switched network, a plurality of structured data records from a terminal device, each structured data record of the plurality of structured data records comprising numerical indicator data and categorical attribute data associated with an entity identifier and a temporal period identifier;
storing the plurality of structured data records in a relational data management device by mapping each structured data record to one or more table entries indexed by the entity identifier and the temporal period identifier;
retrieving, from the relational data management device, a subset of the plurality of structured data records matching a query condition specifying at least one entity identifier and at least one temporal period identifier;
applying, to the retrieved subset, a normalization operation that converts heterogeneous scale ranges of the numerical indicator data into a unified numerical scale to generate normalized indicator data;
computing, based on the normalized indicator data and a set of weight coefficient values, a composite index value for each entity identifier by performing a weighted aggregation operation, and determining a rank position value for each entity identifier relative to other entity identifiers within a defined grouping condition;
generating a structured input sequence for a generative neural network model, the structured input sequence encoding at least a portion of the normalized indicator data, the composite index value, the rank position value, and an instruction character sequence specifying a generation task; inputting the structured input sequence to the generative neural network model to obtain output character sequence data representing inference data generated by the generative neural network model; and
transmitting, via the packet-switched network, the output character sequence data and the composite index value to a terminal device for rendering on a display of the terminal device.
